(19) United States
(12) Patent Application Publication
(10) Pub. No.: US 2025/0099859 A1
(43) Pub. Date: Mar. 27, 2025

(54) INCENTIVIZED GAMING SYSTEMS AND METHODS

(71) Applicant: Zios Inc., Torrance, CA (US)

(72) Inventor: Abdul Aziz Muhammad, Carson, CA (US)

(21) Appl. No.: 18/894,222

(22) Filed: Sep. 24, 2024

Related U.S. Application Data
(60) Provisional application No. 63/585,041, filed on Sep. 25, 2023.

(51) Int. Cl. A63F 13/792

(52) U.S. Cl. CPC A63F 13/792

(57) ABSTRACT

One or more techniques and/or systems are disclosed for generating incentivized games to drive consumer traffic to one or more physical or virtual locations. Interactions of consumers and/or sellers are controlled using one or more gamification or incentivizing applications. A large-scale parallel reality digital platform is provided that hosts an incentivized location-based AR/VR gaming environment. User interactions and consumer traffic are incentivized at specific locations within the parallel reality digital platform. AR/VR leasing and/or renting of space in the virtual environment provides promotional or advertising content.

### CROSS-REFERENCE TO RELATED APPLICATIONS

This application claims priority to and benefit of U.S. Provisional Patent Application Ser. No. 63/585,041, filed Sep. 25, 2023. The entirety of the aforementioned application is herein incorporated by reference.

### BACKGROUND

Driving and maintaining consumer traffic to a specific location (physical and/or virtual) has been a consistent and evolving problem. As technology advances, it is difficult for businesses to determine how to effectively reach and grow target audiences. Incentive and loyalty programs are known to facilitate generating and driving this consumer traffic. However, these programs have difficulty sustaining interest over time and/or often difficult to maintain.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and/or systems are disclosed for generating incentivized games to drive consumer traffic to one or more physical or virtual locations. Interactions of consumers and/or sellers are controlled using one or more gamification or incentivizing applications. A large-scale parallel reality digital platform is provided that hosts an incentivized location-based AR/VR gaming environment. User interactions and consumer traffic are incentivized at specific locations within the parallel reality digital platform. AR/VR leasing and/or renting of space in the virtual environment provides promotional or advertising content.

In one implementation, a gaming and incentive system comprises a processor and a computer-readable medium storing non-transitory instructions that are operative upon execution by the processor to operate one or more of the following: a business path portal configured to allow control of a business experience management sub-system and comprising a business path portal user interface; a gaming user interface configured to allow user interaction with AR/VR experiences managed via the business path portal, the gaming user interface being a software based user interface configured as one of a mobile application user experience, a VR headset application user experience, or a CPU application user experience, the gaming user interface configured to provide information on one or more of AR/VR games, advertisements, experiences, and 3D objects; a location information sub-system configured to present a GPS map via the gaming user interface, the GPS map displaying locations of one or more location-based AR experiences, games, advertising, 3D objects, and events; a consumer path portal configured to allow access to the AR/VR experiences, and receive one or more user inputs to locate, view, interact, and transact with the location-based AR/VR experiences; a prize management system configured to allow management of incentive prizes, including using user behavioral data and algorithms to determine possible rewards, wherein the rewards comprise one of physical rewards and virtual rewards; and a tracking component configured to track user data and provide behavioral analytics.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

FIG. 1 is a block diagram illustrating a gaming and incentive platform according to various implementations.

FIG. 2 is a block diagram illustrating a gaming and incentive system according to various implementations.

FIG. 3 is a block diagram illustrating components of a gaming and incentive platform according to various implementations.

FIGS. 4-7 illustrate operations of the gaming and incentive platform of FIG. 3.

FIG. 8 illustrates a user interface according to an implementation.

FIGS. 9-11 is a flowchart of a process flow illustrating operations according to various implementation of a gaming and incentive platform.

FIG. 12 is a block diagram of an example computing environment suitable for implementing various examples of a gaming and incentive platform.

FIG. 13 illustrates user interfaces according to various implementations.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

The methods and systems disclosed herein, for example, may be suitable for to control interactions of consumers and/or sellers using one or more gamification or incentivizing applications. Various examples provide a computer system and computer-implemented method for creating and providing a large-scale parallel reality digital platform that hosts location-based augmented reality (AR)/virtual reality (VR) experiences, stores and monitors platform and user data, and/or offers advertisement opportunities throughout a virtual world. In some implementations, computer system and computer-implemented method incentivize user interactions and consumer traffic at specific locations within a parallel reality virtual world. Optionally or alternatively, computer systems and computer-implemented methods provide for leasing or renting three-dimensional (3D) space in a virtual environment (e.g., a virtual world) using augmented and virtual reality technology and software configured to provide entry portals or property management portals corresponding to the virtual world. In combination with one or more systems or methods described herein, user data is collected through an augmented reality or virtual reality digital geolocation platform. And, as part of one or more systems or methods, in some examples, a client or business intake path and process is facilitated within a large-scale parallel reality digital platform that hosts location-based augmented reality and virtual reality experiences.

Merchants and other entities often offer loyalty or reward programs as a strategy to encourage business with consumers, and then repeat business with the consumers. The loyalty or reward programs take many forms in different industries, and can include simple programs having a punch card at a local sandwich shop to a reward card that accrues value for transactions at one or more particular merchants. Merchants can expend effort related to the loyalty services in order to retain existing consumers, while also gaining additional consumers, etc. The herein described systems and methods provide an incentive or reward environment, which is accessible to consumers and merchants, where incentives are included by the merchants and then earned and/or achieved by the consumers through interaction and gamification within the environment, particularly an AR environment or a VR environment. In particular, in connection with the incentive or reward environment, a gaming and incentive platform as described herein includes one or more computer implement engines that facilitate providing incentives at the direction of one or more merchants. Consumers are then able to utilize a an AR/VR interface, such as in a portable communication device, to interact with their surroundings (e.g., by location, through virtual characters and entities, etc.) and to navigate within the incentive and reward environment that is gamified to discover and/or unlock and/or achieve the incentives offered by the merchants (generally automatically). As such, the incentives are provided by the merchants into the incentive or loyalty reward environment, which determines certain activities, including, for example, the consumers' presence at the brick and mortar store of the merchants, etc., in order for the consumers to obtain the incentives. The loyalty incentive and reward environment in some examples can be incorporated and/or be interactive with social media to enhance the experience, allowing the consumers to interact with other consumers. Additionally, the incentives obtained in the incentive or reward environment may, in some examples, be saved, combined and/or converted to other incentives, prior to redemption, whereby interactions with the incentive or reward environment over time may allow the consumers to further achieve more valuable incentives.

Thus, improvements to augmented reality and virtual reality systems that provide gamification and incentivization can result in generation and execution of transactions in a faster, less costly, and/or more reliable manner. That is, online implementation of augmented reality and virtual reality systems can be executed with reduced costs, risks, and time associated with offering incentives and procuring products and services. In this manner, when a processor is programmed to perform the operations described herein, the processor is used in an unconventional way that allows for more efficient and reliable online incentivizing and/or procurement or goods and services, which results in an improved user (e.g., consumer) experience. In one more examples, additional foot traffic into brick and mortar stores is achieved from the improved user experience.

It should be appreciated that the herein described examples can be used in different settings or environments, such as for different types of incentivizing and online user experience operations. That is, many different incentives, using different gamification processes in connection with buying or selling different types of good and services at any price point can be provided using one or more platforms as described in more detail herein. In some examples, the techniques described herein can be configured to solve different incentive problems by providing different dynamically configurable and customizable gaming, incentivizing, and/or advertising interfaces. As such, different users of the systems can differentiate offerings by providing different games, incentives, and/or advertisements generated for particular users, applications, environments or use cases. In some examples, users can be offered different game options and/or incentives based on an individual's or entity's particular goals, characteristics, etc.

The herein-described examples may be implemented using computer programming or engineering techniques including computer software, firmware, hardware or any combination or subset thereof, wherein the technical effect may be achieved by performing one or more operations described herein. At least one technical problem with prior incentive platforms is that the systems can require extensive inputs and searching, which can require a large amount or computations or processing, to provide a desired or required output. The systems and methods described herein address this technical problem by improving input and searching/processing operations within one or more platforms, by using at least easier to process criteria and/or processes in some examples. One or more technical effects provided by (i) creating and providing a large-scale parallel reality digital platform that: hosts location-based AR/VR experiences, stores and monitors platform and user data, offers advertisement opportunities throughout a virtual world, (ii) incentivizing user interactions and consumer traffic at specific locations within a parallel reality virtual world, (iii) leasing or renting 3D space in a virtual world using augmented and virtual reality technology and providing entry portals or property management portals corresponding to the virtual world, (iv) collecting user data through an augmented reality or virtual reality digital geolocation platform, and/or (v) facilitating a client or business intake path and process within a large-scale parallel reality digital platform that hosts location-based augmented reality and virtual reality experiences, include one or more of a reduced processor load, less memory space required, reduced hardware requirements, enhanced reliability, and improvements in user interaction (such as improved usability, improved user efficiency, and increased user interaction performance).

In one or more examples, a computer system is configured to provide one or more of a business path portal relating to business experience management (e.g., commercial business portal); an AR/VR user interface having location information integration (e.g., GPS map integration); a consumer path portal providing access to AR/VR features, such as game and incentive features; a prize management system providing management of incentive prizes; and tracking component that tracks user data and proves behavioral analytics.

It should be noted that one or more examples can be implemented in different applications. That is, one or more herein described examples can be configured or implemented in different practical applications across many different industries and sectors, such as, for example, entertainment, employee engagement (e.g., wellness programs or training and development), customer loyalty, education, marketing and sales, healthcare and wellness, social and community building, environment initiatives, financial services, travel and hospitality, and non-profit and charity, among others.

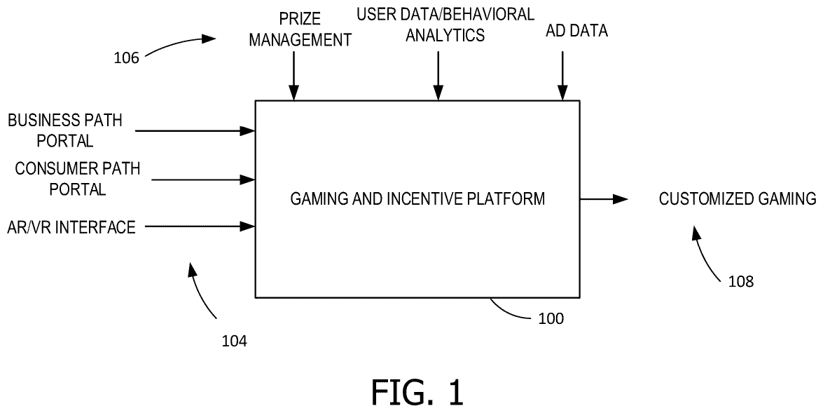

In one or more examples, a gaming and incentive platform 100 is provided as illustrated in FIG. 1. The gaming and incentive platform 100 in various examples is configured as a part of an AR/VR interface that receives one or more inputs 104, such as different inputs 104 from consumers and/or vendors via consumer and/or vendor portals, respectively. In the illustrated example, the inputs 104 include different components, elements, criteria or variables, which can be any inputs that affect the gaming and/or incentive experience. For example, one or more inputs 104 are received from different portals (e.g., business path portal or consumer path portal) or interfaces (e.g., user AR/VR gaming or incentive interface). However, it should be appreciated that the illustrated inputs 104 are merely for example, and other inputs can be used by the gaming and incentive platform 100. That is, the gaming and incentive platform 100 can be configured to generate different types of customized outputs, such as for incentives related to the sale of different goods or the performance of different services.

Using the inputs 104, easily customizable gaming and/or incentive programs can be generated. In various examples, an end-to-end incentivization approach drives consumer activity of traffic to specific locations (e.g., physical or virtual locations) using gamification to facilitate the process. More particularly, in operation, the gaming and incentive platform 100 receives the variables 104 and additional inputs 106 (e.g., prize management information or criteria, user data/behavioral analytics data, and/or advertisement data or criteria), processes the variables 104 and the additional inputs 106, and generates a customized gaming output 108, such as a gamified experience having incentive and advertisement features are described in more detail herein. The gaming and incentive platform 100 allows for dynamically generating many different types of gaming outputs 108 (such as based on different incentives), wherein one or more instances of the gaming output 108 can then be run on a user device, which allows interaction thereof with, for example, a user interface.

In some examples, the gaming and incentive platform 100 can be implemented in software, hardware, or a combination thereof. For example, a series of software packages implementing one or more aspects of the gaming and incentive platform 100 can be provided. In this example, the gaming and incentive platform 100 is configured to generate the one or more customized gaming outputs 108 that are used to incentivize user actions. In some example, the gaming and incentive platform 100 is configured as a host platform for one or more AR/VR games, experiences, activities, etc.

In some examples, the gaming and incentive platform 100 is configured to generate a preprogrammed, predefined, or user customized reward environment using the customized gaming output 108. For example, by providing incentives and including the incentives in a reward environment, the merchant (via a gaming engine or platform) engages the consumer in a AR game or a VR game to obtain the incentives, which, depending on the incentives, permits the merchant to increase the consumer's presence at the merchant, increase purchases at the merchant, and increase loyalty of the consumer to the merchant. And, in some examples as described herein, permits the consumer to quickly and easily convert and/or exchange the obtained incentives, which adds a level of consumer control to the incentive delivery, thereby permitting the consumer to be involved in tailoring the incentives to the consumer's likes, dislikes, etc. As can be appreciated, this can increase the efficiency of the incentives for the merchant, over other known methods for disseminating incentives to consumers. As such, systems and methods described herein facilitate driving consumer traffic and/or generating or maintain consumer loyalty through gamified incentive environments, and in some examples, for building consumer loyalty to merchants via incentives from the merchants included in the gamified incentive environments, and through which the consumers are permitted to navigate and earn the incentives.

In one example, empirical, experimental or simulation data is used to train or configure the gaming and incentive platform 100, and then the inputs 104 additional inputs 106, are processed to generate the customized gaming output 108. In some examples, machine learning is used to train or configure the gaming and incentive platform 100 based on a training data from simulations or feedback received from previously generated customized gaming outputs 108. In some examples, artificial intelligence (AI) is used as part of the training of and/or processing by the gaming and incentive platform 100 to generate improved gamification and incentivizing.

It should also be appreciated that the gaming and incentive platform 100 is not limited to generating specific types of gaming and/or incentivizing outputs, but can be used to generate gaming and/or incentivizing outputs for many different applications. Additionally, the goods and/or services provided in connection with the gaming and incentivizing can include different good/services.

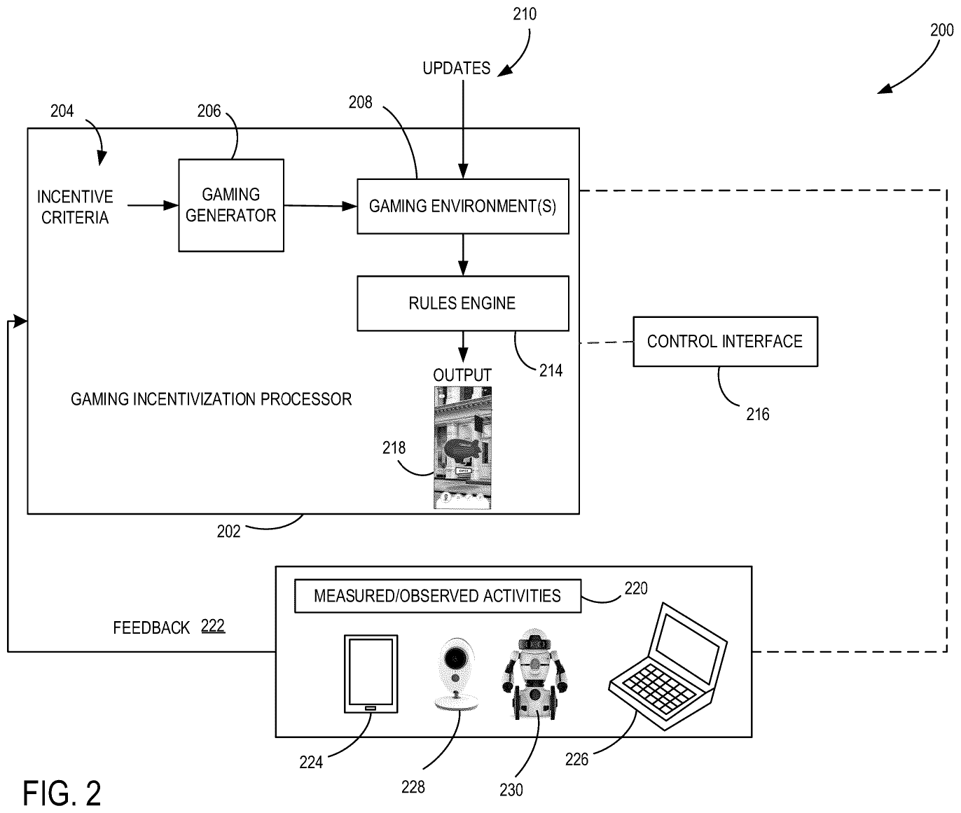

One particular implementation includes a gaming and incentive system 200 as illustrated in FIG. 2. In some examples, the gaming and incentive system 200 is implemented as part of or includes the gaming and incentive platform 100. The gaming and incentive system 200 in one example is a processing machine that can be used in combination with one or more other systems (e.g., monitoring systems, data analytics systems, advertising systems, prize management systems, etc.) to generate one or more customized gaming output, such as incentivized gaming outputs. More particularly, the gaming and incentive system 200 includes a gamified incentivization processor 202 that is configured as a processing engine that performs operations to generate one or more gaming outputs to incentivize the purchase or use of one or more products and/or services on one or more input data 204, illustrated as incentive criteria (which in some examples relate to goods or services). It should be noted that the input data 204 can include different types of data configured in different ways corresponding to different types of incentives, games, goods and services. It should also be noted that the examples described in the present disclosure can be applied to different types of data, including non-gaming data. In some examples, the input data 204 is obtained via a user interface (e.g., one or more of the user interfaces) having selectable elements or fields that are capable of user interaction.

In operation, the gamified incentivization processor 202 has access to the input data 204, such as the different types of inputs 104 and performs one or more operations as described in more detail herein, such as to generate incentivized games to drive consumer traffic. It should be appreciated that the gamified incentivization processor 202 is configured to perform gamified incentivization in a wide variety of application domains. For example, the implementations of the present disclosure provide for incentivized gaming generation and execution in a consumer domain, but various implementations can be used in other domains, such as within a business domain or a government domain.

In the illustrated example, the input data 204 includes incentive criteria, such as requirements, variables, etc. relating to one or more of a sale of goods and/or services, wherein the gamified incentivization processor 202 processes the input data 204 using a gaming generator 206 as described in more detail herein. In some examples, the gaming generator 206 uses one or more computer processors to process the input data 204 using one or more algorithms or data structure processing engines that use different types of information corresponding to the input data 204 to create, for example, one or more gamified incentive environments 208 based on the input data 204 that is dynamically updated in some examples. That is, the gaming generator 206 generates game and/or incentive options based on the incentive criteria 204. For example, one or more incentivized game features relating to a particular vendor, loyalty/reward program, current promotion, good/service, etc. are generated as part of the gaming environment 208, which game features (e.g., options or components relating to incentives) can be modified (such as based on one or more updates 210) and/or accepted. It should be noted that the generation of the gaming environment 208 in some examples is an iterative process as described in more detail herein. As such, the input data 204 is used to determine or define elements for a desired or required incentivized gaming experience or environment based on the received input data 204.

In the implementation illustrated in FIG. 2, the gamified incentivization processor 202 performs processing using different incentive criteria or other data to generate an output. For example, gamified incentivization processor 202 applies a rules engine 214 to construct a finalized gaming interface 218 is output to a user, and which in various examples, allows for user interaction (e.g., playing the game to obtain one or more rewards or incentives).

In some examples, a control interface 216 is configured to allow interaction with the gamified incentivization processor 202. For example, the control interface 216 includes one or more user interfaces, such as part of the business path portal or the consumer path portal, configured to receive the input data, as well as other information, such as feedback 222 as described in more detail herein. That is, the control interface 216 allows for user inputs or other inputs to be received and utilized by the gamified incentivization processor 202 in incentivized gaming generation as described in more detail herein. In some examples, the control interface 216 is a consumer or business specific centric interface that initiates incentivized gaming

In one or more examples, results from one or more incentivized games, or other incentivization experiences, are provided as the feedback 222 to the gamified incentivization processor 202. For example, with the input data 204 processed as described above, the gamified incentivization processor 202 generates a finalized output, which is used to produce the finalized gaming interface 218. The feedback 222 in various examples is used to confirm performance, which in some examples, includes confirming that one or more gaming actions/tasks are performed.

Various inputs and/or operations can be performed using one or more end user devices, for example, a smart phone 224, a laptop computer 226, or other end user computing device, which allow for user input. In some examples, one or more monitoring devices, such as a camera 228 (or other imaging or non-imaging sensor) or robot 230 are configured to acquire information and automatically provide information, which can include the feedback 222. It should be noted that in some examples, the gaming and incentive platform 100 or components thereof are configured as a downloadable application that can be stored and loaded to one or more of the end user devices. The end user device is able to use the gaming and incentive platform 100 to interact with one or more elements of the gaming interface 218 in an AR or VR environment.

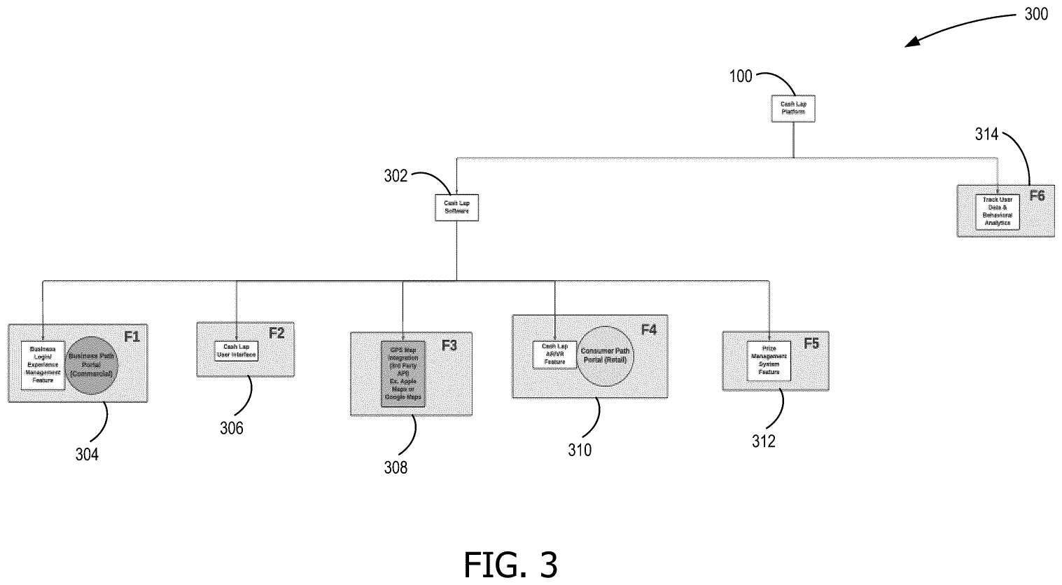

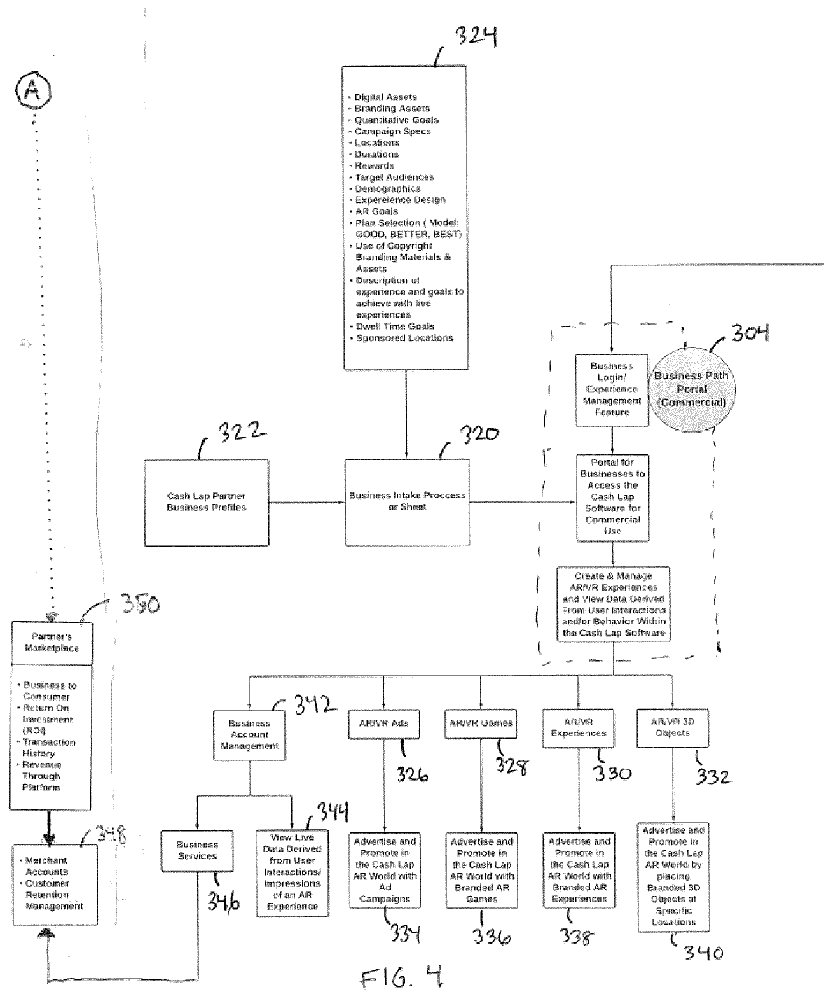

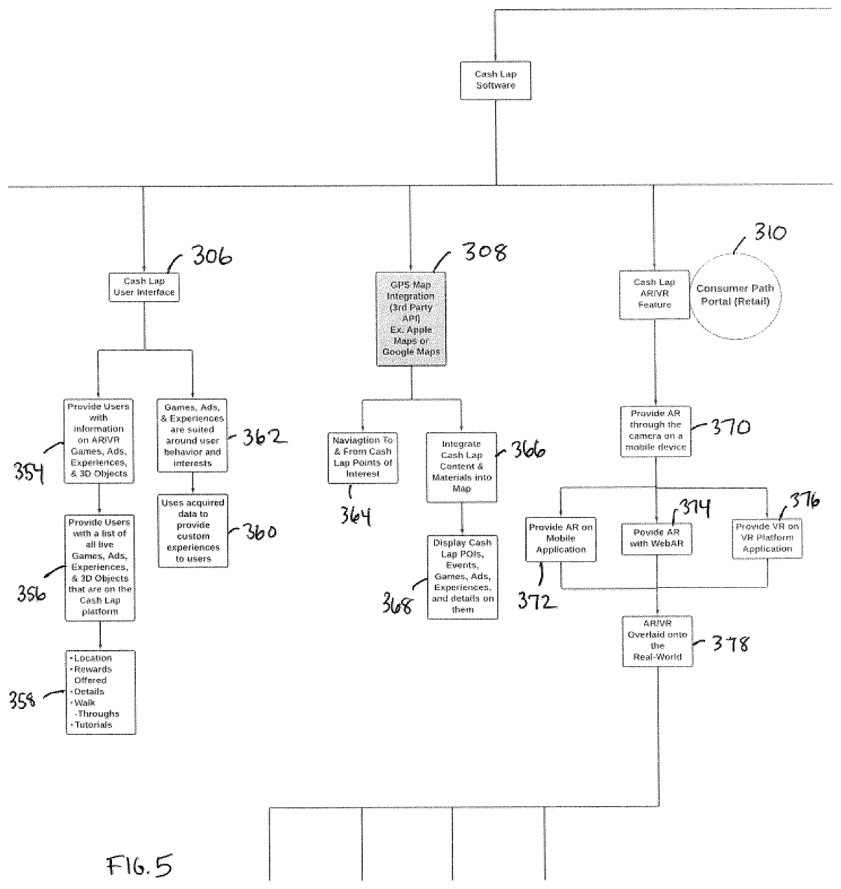

In some implementations, the gaming and incentive platform 100 and/or the gamified incentivization processor 202 is operable and configured to perform one or more operations described in more detail herein. The gaming and incentive platform 100 is configured to operate in some examples as illustrated in FIG. 3. In this example, and with reference also to FIGS. 4-7, the gaming and incentive platform 100 provide software functionality 302 that includes one or more of the following:

1. A business path portal 304 relating to business experience management (e.g., commercial business portal). In some examples the business path portal 304 is a user interface feature of the commercial side of the gaming and incentive platform 100. The business path portal 304 is configured to allow businesses or other entities/partners to create and manage one or more aspects of the incentivized gaming application, such as the AR/VR experiences, including the gaming environment 208 and the gaming interface 218. The business path portal 304 is further configured in some examples to allow viewing of data derived from user interactions and/or behavior while using the gaming and incentive platform 100.

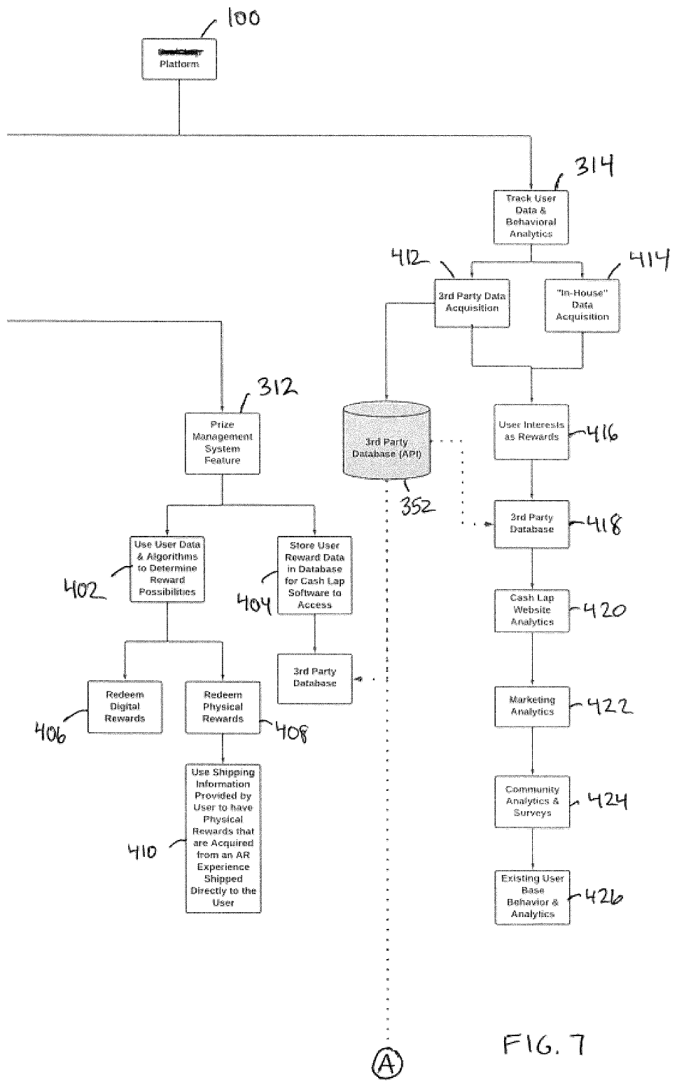

As can be seen in FIG. 4, the business path portal 304 is configured to allow login and management to the gaming and incentive platform 100 for commercial use to access a business intake process or business intake data 320 that includes one or more partner business profiles 322. The business intake data 320 includes information 324 regarding the business, such as Digital Assets, Branding Assets, Quantitative Goals, Campaign Specs, Locations, Durations, Rewards, Target Audiences, Demographics, Experience Design, AR Goals, Plan Selection (Model: GOOD, BETTER, BEST), Use of Copyright Branding Materials and Assets, Description of experience and goals to achieve with live experiences, Dwell Time Goals, Sponsored Locations, etc. The business path portal 304 also allows for creating and managing AR/VR experiences and viewing data 344 derived from user interactions and/or behavior within the gaming and incentive platform 100 through a business account management system or interface 342. In operation, using the business path portal 304, access to at least one or more of the following are provided: AR/VR advertisements 326, AR/VR games 328, AR/VR experiences 330, and AR/VR objects 332, which can be advertised and promoted in the gaming and incentive platform 100 using advertising and promotion components or systems 334, 336, 338, 340. It should be noted that the business account management system or interface 342 is also configured to allow access to business services systems 346 that have stored data 348 relating to, for example, merchant accounts and customer retention management, as well as partner marketplace data 350 stored in a third party database 352 (see FIG. 7).

2. A user interface 306 (e.g., an AR/VR user interface) configured to allow user interaction with the AR/VR experiences, including the gaming environment 208 and the gaming interface 218. For example, the user interface 306 is a software based user interface configured as a mobile application user experience, a VR headset application user experience, a CPU application user experience, etc. The user interface 306 is configured to provide users with information 354 on AR/VR games, advertisements, experiences, and 3D objects, among others, using acquired data from user behaviors while using the gaming environment 208 and the gaming interface 218. In some examples, the information 354 includes lists of live experiences 356, as well as additional information 358 related to rewards. The user interface 306 is configured to use acquired data 360 to provide custom experiences to the user based on, for example, data 362 relating to the behavior and/or interests of the user.

3. Location information functionality 308 in some examples includes a GPS map feature. The location information can include GPS map integration from a third-party section of the user interface in which users can use the map to view a list of locations of location-based AR experiences, games, advertising, 3D objects, and events. The location information functionality 308 provides a navigation component 364 that allows navigation to points of interest in a virtual map (e.g., locations having VR gaming incentive events), and also includes integrated content 366 on the map in addition to points of interest, such as one or more events, advertisements, experiences, etc.

4. A consumer path portal 310 providing access to AR/VR features, such as game and incentive features relating to the consumer experience (e.g., consumer portal). In some examples the consumer path portal 304 is a user interface feature of the consumer side of the gaming and incentive platform 100. The consumer path portal 310 is configured to allow users access to the gaming environment 208 and the gaming interface 218 on the retail side, such as an AR/VR world or metaverse in which the users can locate, view, interact, and transact with location-based AR/VR experiences. In some examples, commercial or business access is also provided to platform data that facilitates in providing information relating to overall sales and allows business to access the gaming side of the platform for commercial use.

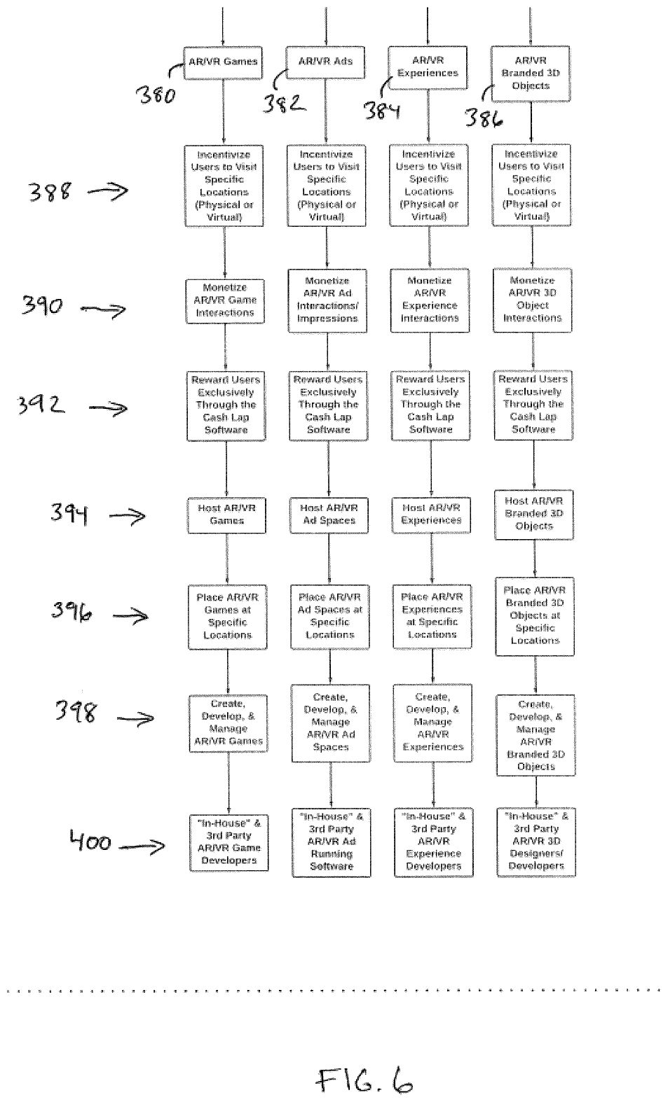

The consumer path portal 310 includes an AR component 370 that provides AR functionality, such as through the camera on a mobile device. In some examples, the AR functionality or content is provided on one or more of the mobile application 372, with a WebAR 374 and/or in combination a VR platform application 376. In one or more examples, overlaid AR/VR data 378 is provided on a real-world or live view being displayed and corresponding to the view through, for example, the camera on the mobile device. In some examples, the AR/VR data 378 includes one or more of AR/VR games 380, AR/VR advertisements 382, AR/VR experiences 384, and AR/VR branded 3D objects 386, among other data or objects (see FIG. 6). The data is configured to incentivize users to visit specific locations at 388, monetize interactions at 390, reward users at 392, host AR/VR experiences at 394, place AR/VR data at locations at 396, create, develop, and manage AR/VR content at 398, and/or provide in-house content at 400, among others.

4. A prize management system 312 providing management of incentive prizes, including using user behavioral data and algorithms to determine possible rewards. The user behavioral data in some examples is stored in a user database for later access as described in more detail herein. For example, user data is analyzed or processed with one or more algorithms at 402 to determine reward possibilities and the user reward data stored at 404. The reward possibilities allow users access to and redemption of digital rewards 406 or physical rewards 408. It should be noted that physical rewards 408 are sent to the user based in shipping information 410.

5. A tracking component 314 that tracks user data and provides behavioral analytics. For example, the tracking component in one or more examples is configured to provide one or more of: data tracking, data monitoring, data storage, marketing materials, accurate analytics, user behaviors, user interests, groups users by demographics, groups users by interests, sales materials, pitch materials, custom user interface data, platform gamification data, commercial use planning, key resource for the gaming and incentive platform 100. The tracking components 314 is configured to acquire data using third party data acquisition 412 and in-house data acquisition 414. The acquired third party data is stored in the third party database (API) 352 in some examples. The tracking component 314 is configured to analyze or process the data to determine one or more of user interests 416, process the third party data 418, perform website analytics at 420, perform marketing analysis at 422, perform community analytics and surveys at 424, and/or perform existing user base behavior analytics at 426.

In one or more examples, the gaming and incentive platform 100 provides users with actual goods and services through gamification for a reduced cost (e.g., fraction of actual cost) compared to conventional incentive programs. The gaming and incentive platform 100 provides businesses with sell-through opportunities that generate revenue and assist in the growth of the audiences for both parties. In some examples, the gaming and incentive platform 100 is a mobile platform that generates increased revenue opportunities using software, partnerships, and scaled platform monetization. For example, as described in more detail herein, with a more efficient user interface that provide an improved user experience, the gaming and incentive platform 100 generates and drives consumer traffic to specific locations (physical and/or virtual) using gamification to facilitate the process.

In one implementation, the gaming and incentive platform 100 allows users to (1) access/download an application and create a user account. Upon account creation, users have the ability to use tools provided by the gaming and incentive platform 100 (e.g., application software) such as: (2) an integrated map feature that displays the user's location along with different points of interest and the details/relevance of each one to the user and his or her physical location in the world, (3) an AR camera feature that allows users to view and interact with content/games/experiences overlaid onto the real world (e.g., a live image), (4) an account management feature which allows users to change personal information that is used to identify the users on the platform, wherein a gamified user interface/experience incentivizes users to visit physical and/or virtual locations, (5) advertising and promotional opportunities are integrated into the application's gamified interface as well as the AR camera feature using custom 2D design, 3D design, marketing, and experience design. In some implementations, secure databases are used to store user data, behavioral analytics, games/experiences/locations, software assets, etc.

In some implementations, the gaming and incentive platform 100 is configured using a model (e.g., business model) that monetizes user actions/interactions on the software, as well as platform partnerships. The model scales with the gaming and incentive platform 100 as the gaming and incentive platform 100 increases or decreases in value. The gaming and incentive platform 100 is configured to allow multiple partnerships with companies and brands (e.g., national and international) using programmed software algorithms to ensure the accuracy, efficiency, and functionality of the model. Partnering brands in some examples are required to provide a minimum number of product(s) and/or exclusive offers that are disbursed as prizes/rewards to users/consumers using the gaming and incentive platform 100. Users are offered ease of access throughout the gaming and incentive platform 100 with features such as QuickPay methods and linking payment methods. And, (6) an in-application store where users can purchase virtual currency to be used to engage in certain experiences.

Thus, the gaming and incentive platform 100 generates revenue opportunities using and rewards users with real life rewards that can be instantly redeemed through the gaming and incentive platform 100 when obtained. Physical rewards are shipped directly to users from the facilities of the partnering companies in some examples, while digital rewards can be redeemed and managed within the gaming and incentive platform 100 (e.g., the gaming application). The gaming and incentive platform 100 provides businesses with the ability to market “in” and “on” real life real locations and real estate around the world for a fraction of the costs to do the same with actual scaled physical materials.

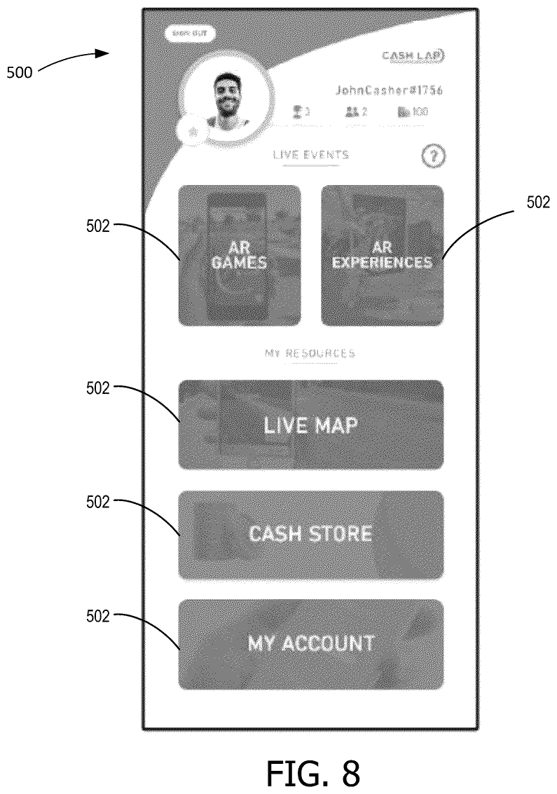

In some examples, a user interface 500 as illustrated in FIG. 8 allows access to the gaming environment 208 using the gaming interface 218. That is, the user interface 500 allows access to one or more features of the gaming and incentive platform 100. As can be seen, the user interface 500 includes user selectable elements 502 displayed by the user interface 500 that can access one or more live events, such as AR games, AR experiences, and one or more resources, such as a live map, a cash store, or account information (My Account). In one or more examples, the live events include incentivized gaming events and other experiences that utilize AR and/or VR elements. In various examples, the user interface 500 allows access to different features and functionality of the gaming and incentive platform 100, for example, participating in loyalty or incentivized gaming events, managing awards, including electronic or physical delivery of rewards or reward items, etc. It should be noted that the user interface 500 is one example of an interface configured to access the gaming and incentive platform 100. Other user interfaces, applications, etc. are contemplated that allow access to front-end and back-end features and functionality of the gaming and incentive platform 100. For example, one or more user interfaces are configured to allow access to the consumer side (e.g., consumer path portal) and/or to allow access to the business side (e.g., business path portal).

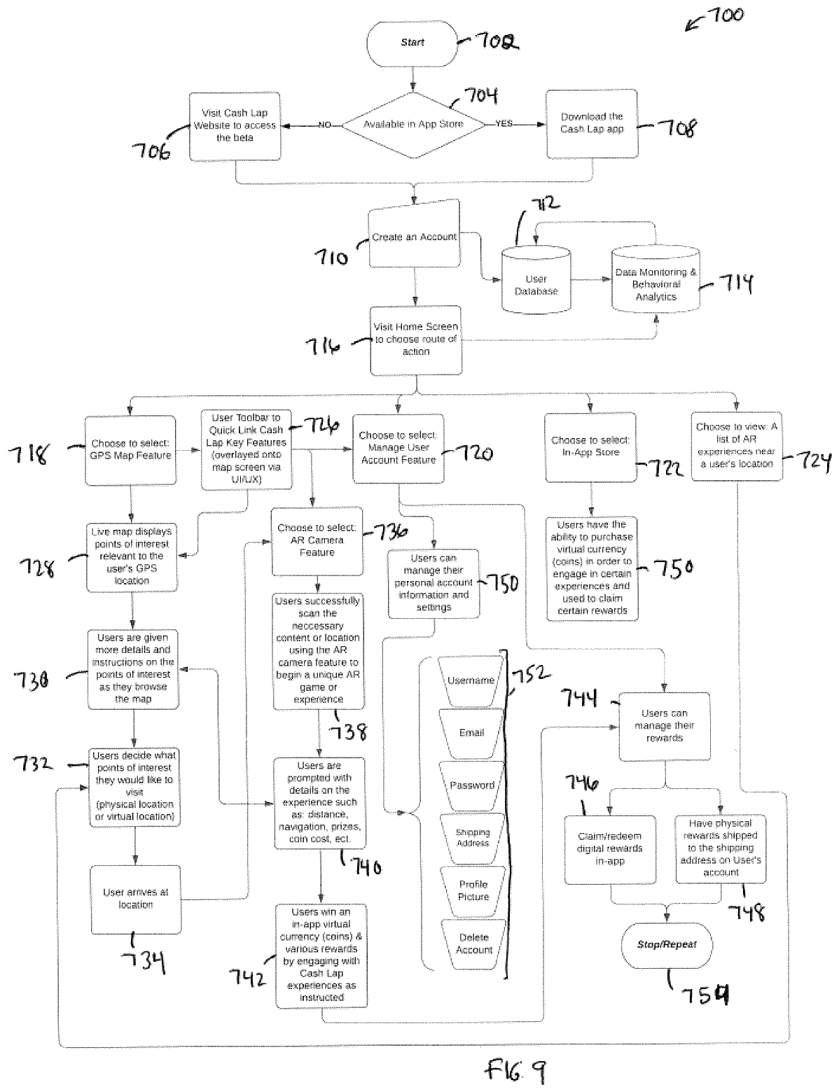

The gaming and incentive platform 100 and/or the gaming and incentive system 200 is operable and configured to perform one or more operations as illustrated in FIGS. 9-11. It should be noted that the operations can be performed in a different order than shows, additional or fewer operations performed, and performed simultaneously, concurrently, or sequentially. As can be seen, in one implementation, a method 700 begins at 702 and a determination is made whether an application to access the gaming and incentive platform 100 and/or the gaming and incentive system 200 is available at an application store at 704. If the application is not available at the application store, the application can be downloaded through a local website at 706. If the application is available at the application store, the application is downloaded from the application store website at 708. A user account is then created at 710 and stored in a user database at 712. The user account is monitored at 714, including performing data monitoring and behavioral analytics.

With access to the application and an account created, a home screen is presented (e.g. displayed on the user device) at 716. For example, the user interface 500 is displayed on the user device. Using the home screen, selection can be made of a GPS map feature at 718, a manage user account feature at 720, an in-app store feature at 722, or an AR experiences list feature at 724. In response to selection of the GPS map feature at 718, gaming features and information are overlaid on the map screen at 726 and can include live map displays of points of interest at 728 that can be browsed at 730 to obtain more information. The information allows users to identify at 732 one or more physical locations or virtual locations corresponding to a point of interest (e.g., incentivized game or reward of interest). A user then travels to the location at 734, which is physical travel in some examples, and virtual travel in other examples. For a physical location selection, an AR camera feature is selected at 736 that allows the user to scan one or more required content or location features at 738 to begin the AR game or experience. Information regarding the experience is presented at 740, such as distance to AR game, navigation details, prizes, cost, possible rewards, etc. By participating in the AR event or activity (e.g., AR game in a portion of the store) or VR event or activity, rewards are provided at 742 and can be managed at 744. For example, one or more digital rewards can be redeemed in the application at 746 or physical rewards can be selected for delivery at 748. It should be noted that management of the rewards at 744 can be accessed directly by selecting the manage user account feature at 720, which also allows for management of personal account settings at 750, such as one or more profile settings 752.

It should be noted that selection of the in-app store at 722 results in additional functionality being presented to the user at 750, such as the ability to purchase virtual currency to engage in certain experiences and then used to claim rewards. It should also be noted that selection of the list of AR experiences at 724 results in a display of the AR experiences from which the user can identify ones of interest at 732. The method 700 ends at 754.

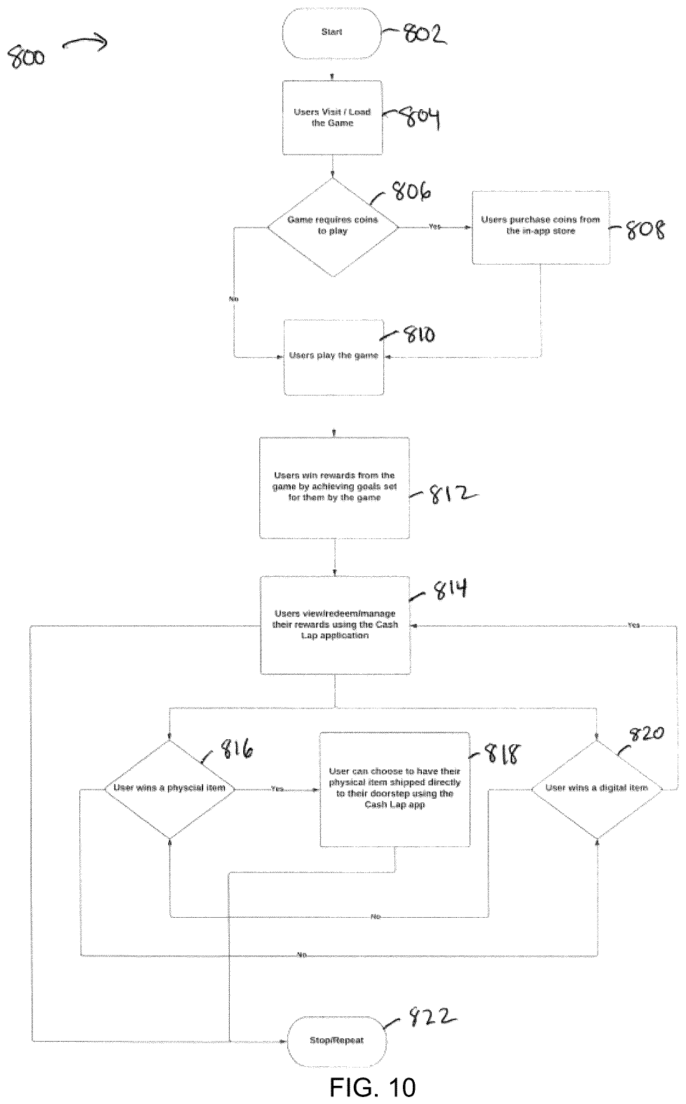

With reference now to FIG. 10, a method 800 starts at 802 and allows users to visit or load the game (e.g. incentivized AR game) at 804. A determination is made at 806 whether payment (e.g., virtual coins) are needed to play. If payment is needed, then virtual currency can be purchased from the app-store at 808, which can be performed using any suitable online or virtual purchase technology. Once currency is purchased or if no payment is required, the game is accessed at 810 and played by the user (e.g., play AR game at physical location or retail store). Rewards are won at 812 by achieving goals or performing certain actions in the game and the users can view, redeem, and/or manage the rewards at 814. For example, a determination if made at 816 whether a user won a physical item. If the user won a physical item, a delivery option is presented at 818. If the user did not win a physical item, a determination is made at 820 whether the user won a digital item. If the user won a digital item (e.g., online coupon), the item can be managed or redeemed at 814. If the user did not win a digital item, and as such won no item, the method ends at 822.

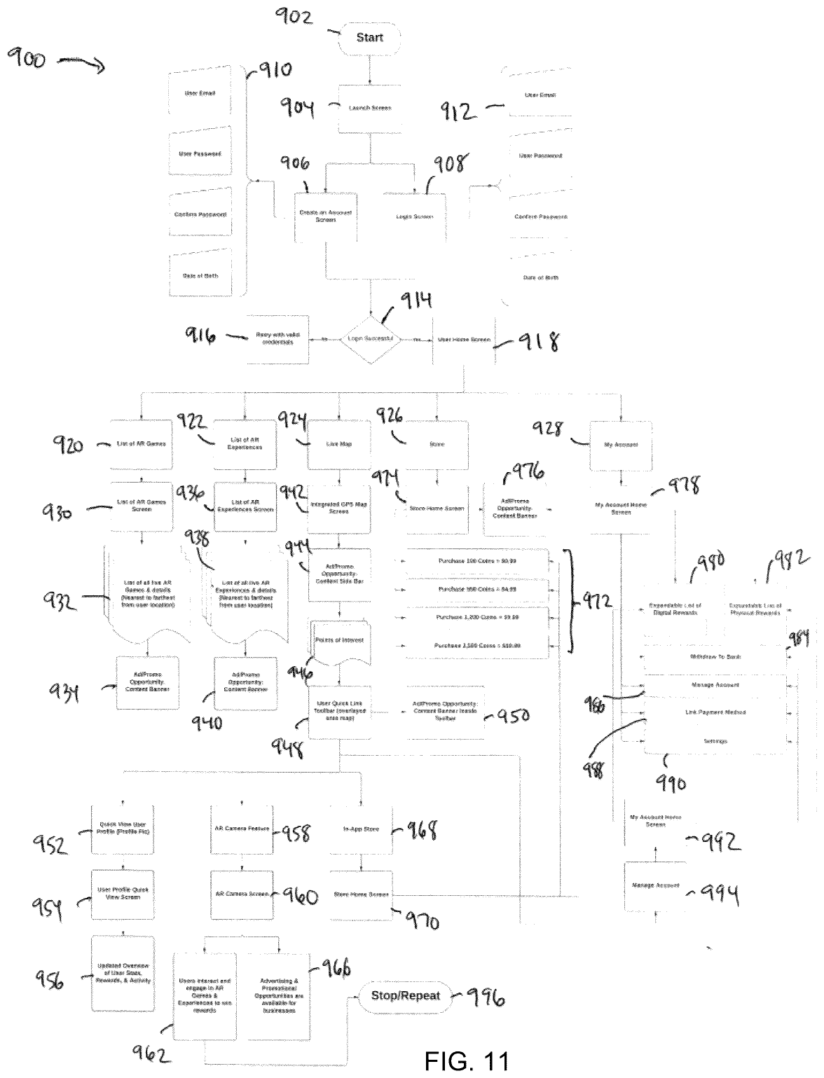

With reference now to FIG. 11, a method 900 starts at 902 and allows users to access a launch screen at 904. For example, the user interface displays a launch screen that allows for creating an account at 906 or logging into the system at 908. If account creation is selected then user details 910 are received from the user. If login is selected then login credentials 912 (e.g., user login information) are received from the user. A determination is then made at 914 whether log in was successful. If not successful, then the login credentials 912 are input again at 916. If the login was successful, then at 918 a user home screen is presented to the user. Access is then provided to one or more options or functionality of the user interface (e.g., the gaming interface 218), such as a list of AR games at 920, a list of AR experiences at 922, a live map at 924, a store at 926, and account information at 928. Each of these will now be described.

The list of AR games is displayed on an AR games screen at 930 and includes details of the games at 932, which are sorted in some examples based on geographic distances from the location of the user (e.g., nearest game listed first). It should be noted that a promotion opportunity or content banner is added at 934 in some examples. The list of AR experiences is displayed on an AR experiences screen at 936 and includes details of the games at 938, which are sorted in some examples based on geographic distances from the location of the user. It should be noted that a promotion opportunity or content banner is added at 940 in some examples.

The live map is displayed as part of an integrated GPS map screen at 942 with a promotion opportunity or content banner added at 944 in some examples. Points of interest are presented (e.g., displayed on the map) at 946 and a toolbar overlaid at 948 in some examples. A promotion opportunity or content banner is added inside the toolbar at 950 in some examples. The toolbar allows access to quick view user details at 952 on a quick view screen at 954, which can also include presenting updated user statistics, rewards, and activities. The toolbar also allows access to an AR camera feature at 958 using an AR camera screen at 960 that allows users to interact and engage in AR games and experiences at 962 to win awards as described in more detail herein. Advertising and promotional opportunities are provided at 966 in some examples. The toolbar also allows access to an in-app store at 968 displayed on a store home screen at 970. The home screen allows purchase of virtual currency at 972, such as virtual coins.

The store screen can be accessed at 974 directly from the user home screen. Advertising and promotional opportunities in a content banner are provided at 976 in some examples. The account information accessed at 928 is presented on a my account home screen at 978, which includes an expandable list of digital rewards at 980 and an expandable list of physical rewards at 982. The account screen also provide additional functionality including a withdraw to bank feature at 984, a manage account feature at 986, a link payment method feature at 988 and a setting feature at 990. These features allow for management of payment options in some examples. It should be noted that the account home screen can be accessed from other screens at 992 by selecting a manage account feature at 994. The method ends or is repeated at 996.

Variations and modifications are contemplated. For example, in combination with or as part of the gaming and incentive platform 100 and/or the gaming and incentive system 200, advertising space is provided in the “AR world”. That is, virtual advertising in the AR gaming environment is generated based on advertising or promotional opportunities as described in more detail herein. In some examples, the AR advertising space is rented or leased to one or more merchants or business to allow AR advertising during operation of the gaming interface 218. In some examples, similar advertising space is provided in a physical setting, such as using one or more drones operating to display the advertising or promotional opportunities. In some examples, the advertising or promotional display is selected based on a user profile of the user accessing the gaming interface 218.

In one more examples, the gaming and incentive platform 100 and/or the gaming and incentive system 200 are configured to provide one or more of the following:

1. A computer-implemented method for providing a large-scale parallel reality digital platform that hosts location-based augmented reality and virtual reality experiences while storing and monitoring platform and user data. The method involves hosting a plurality of augmented and virtual reality experiences, receiving requests from partners to include virtual elements in the virtual world corresponding to real-world locations and user behavior, selecting and modifying platform data based on the requests, providing the modified data and experiences to users' camera-equipped client devices, rewarding users when they are physically near and/or interact with an AR/VR experience at the real-world locations associated with the requests, facilitating in-app transactions made by the users, shipping physical reward items to users.

2. The computer-implemented method described herein includes a process for hosting a parallel reality digital platform, as follows:

2a. Hosting the Parallel Reality Platform: The method begins by hosting a parallel reality digital platform on a server and/or database. This platform consists of a virtual world that closely mirrors the real world, allowing users to navigate it using their client devices' cameras and move to different locations in the real world.

2a (Expanded):
Web Development Frameworks: Django (Python), Ruby on Rails (Ruby), Laravel (PHP), or Node.js (JavaScript). These frameworks provide the necessary tools for building scalable web applications.
Augmented Reality (AR) Development: ARCore (for Android), ARKit (for iOS), or Unity 3D with Vuforia. These tools provide libraries, APIs, and functionality specifically designed for AR development.
Virtual Reality (VR) Development: Unity 3D or Unreal Engine. These tools provide powerful capabilities for building immersive VR experiences across multiple platforms.
Geolocation and Mapping: Google Maps API, Mapbox, or OpenStreetMap. These tools provide geolocation services, mapping capabilities, and routing functionalities.
Cloud Services: Amazon Web Services (AWS), Microsoft Azure, or Google Cloud Platform (GCP) are used for hosting web applications, storing and serving assets, managing databases, and scaling infrastructures.
Database Management: PostgreSQL, MySQL, MongoDB, or Firebase Realtime Database.
Frontend Technologies: HTML5, CSS, and JavaScript along with frontend frameworks React, Angular, or Vue.js. These frameworks provide efficient UI development and help create responsive, interactive user interfaces.
API Development and Integration: To integrate with external services or provide an API for third-party developers, we build RESTful APIs. Django REST Framework (Python), Express.js (Node.js), or Ruby on Rails will facilitate API development.

2b. Transmitting Platform Data to the User: The platform server and/or database transmit platform data to the client device of a user. This data indicates the presence of a virtual element at a specific virtual location in the virtual world, corresponding to a particular location in the real world. Notably, the user's client device is physically located at a different second location in the real world.

2b (Expanded):
Backend Framework: Node.js, Django (Python), Ruby on Rails (Ruby), or Laravel (PHP). These frameworks offer features for efficient data processing, handling concurrent connections, and managing server-side logic.
WebSockets: WebSockets provide a persistent connection between the server and clients, enabling real-time bidirectional communication. Socket.IO (JavaScript), Django Channels (Python), or Action Cable (Ruby on Rails) can help implement WebSockets.
Messaging Queues: RabbitMQ, Apache Kafka, or AWS Simple Queue Service (SQS) enable efficient message processing and can handle high volumes of data.
Content Delivery Network (CDN): CDNs include Cloudflare, Amazon CloudFront, or Akamai.
Caching Mechanisms: Redis or Memcached can store frequently accessed data in memory, enabling faster retrieval and reducing the need for repeated data processing.
Data Storage: PostgreSQL or MySQL handle structured data. NoSQL databases like MongoDB or Cassandra manage large volumes of unstructured or semi-structured data.
API Design and Integration: RESTful API frameworks Express.js (Node.js), Django REST Framework (Python), or Ruby on Rails for efficient API development and integration.
Infrastructure and Scalability: Amazon Web Services (AWS), Microsoft Azure, or Google Cloud Platform (GCP). Services like auto-scaling, load balancers, and containerization (e.g., Docker) are used to handle increasing user loads and ensure high availability.
Security Measures: Encryption protocols (e.g., SSL/TLS) for data in transit, authentication and authorization mechanisms.

2c. Receiving Position Information: As the user travels from their current second location in the real world to the first location mentioned in the platform data, the platform server and/or database receive position information from the client device. This information tracks the user's movement and position updates.

2c (Expanded):
Global Navigation Satellite Systems (GNSS): GPS (Global Positioning System), GLONASS, Galileo, or BeiDou provide accurate positioning data. These systems rely on satellite signals to determine precise location information.
Location-based Services (LBS) APIs: Google Maps API, Mapbox, or OpenStreetMap APIs. These APIs offer functionalities for geocoding, reverse geocoding, and retrieving location data.
Mobile Development Frameworks: React Native, Flutter, or Xamarin. These frameworks provide cross-platform capabilities, allowing you to build apps for both iOS and Android. They also provide access to device-specific location APIs for retrieving positioning information.
Backend Framework: Node.js, Django (Python), Ruby on Rails (Ruby), or Laravel (PHP) to handle the server-side logic.
Database Management: PostgreSQL, MySQL, or MongoDB handle location-based data. Spatial extensions (e.g., PostGIS for PostgreSQL) to enable advanced spatial queries.
Real-time Data Processing: WebSockets, MQTT (Message Queuing Telemetry Transport), or Apache Kafka for data streaming and processing.
Geofencing: Libraries and/or APIs specific to the chosen backend framework and/or geolocation services to implement geofencing.
Cloud Services: Amazon Web Services (AWS), Microsoft Azure, or Google Cloud Platform (GCP) handle location data at scale. AWS Location Service, Azure Maps, or Google Maps Platform to access advanced location-based functionalities and scale the infrastructure as needed.
Security Measures: Implement proper security measures to protect location data and ensure privacy. Follow security best practices for data transmission, authentication, and authorization. Additionally, comply with applicable data protection regulations to maintain user privacy.

2d. Performing Platform Task or Objective: The user's objective is to perform a platform task or objective associated with the parallel reality platform. They are required to reach the first location mentioned in the platform data.

2d (Expanded):
Backend Framework: Node.js, Django (Python), Ruby on Rails (Ruby), or Laravel (PHP). These frameworks offer features for handling user authentication, task creation, progress tracking, and data management.
Database Management: PostgreSQL or MySQL, or NoSQL databases like MongoDB or Firebase Realtime Database. Evaluate the data structure and scalability needs when choosing a DBMS.
API Development and Integration: Implement a RESTful API to expose tasks and objectives to users and allow seamless integration with other platform components. Express.js (Node.js), Django REST Framework (Python), or Ruby on Rails help in developing and maintaining APIs.
Real-time Updates: WebSockets, MQTT (Message Queuing Telemetry Transport), or Server-Sent Events (SSE). These technologies allow for instant communication and can enable real-time progress tracking or task notifications.
User Interfaces: For the frontend development, web technologies such as HTML5, CSS, and JavaScript along with frontend frameworks like React, Angular, or Vue.js. These frameworks provide efficient UI development, allowing the creation of user-friendly interfaces for displaying tasks and objectives.
Mobile Development Frameworks: React Native, Flutter, or Xamarin. These frameworks provide cross-platform capabilities, allowing the development of tasks and objective features for both iOS and Android platforms.
Notifications and Communication: Firebase Cloud Messaging, Apple Push Notification Service (APNs), or SMS gateways are utilized for sending notifications to users based on their preferences.
Scalability and Cloud Services: Amazon Web Services (AWS), Microsoft Azure, or Google Cloud Platform (GCP) handle scalability and ensure high availability. Cloud services such as auto-scaling, load balancing, and containerization (e.g., Docker) are utilized to handle increasing user loads.
Security Measures: Implementing appropriate security measures to protect user data, task details, and user progress. Employ secure authentication and authorization mechanisms, follow security best practices, and comply with data protection regulations to ensure user privacy and data security.

2e. User Interaction with Virtual Element: Once the user arrives at the first location, they can view or interact with the virtual element present there. This interaction is captured by the user's client device, which takes a scan of the environment using its camera.

2e (Expanded):
Augmented Reality (AR) Development: ARKit (for iOS), ARCore (for Android), Unity 3D with Vuforia, or Unreal Engine. These frameworks provide tools and libraries for creating immersive AR experiences.
Mobile Development Frameworks: React Native, Flutter, or Xamarin.
Web Development Frameworks: A-Frame, Three.js, or Babylon.js. These frameworks enable the creation of interactive 3D and AR experiences that can be accessed through web browsers.
User Interaction: Touch gestures, object manipulation, voice commands, or hand tracking. Depending on the chosen AR framework, the platform may have built-in support for these interactions or need to utilize additional libraries or APIs specific to the platform.
Backend Framework: A backend framework handles the server-side logic required for virtual element interactions. Node.js, Django (Python), Ruby on Rails (Ruby), or Laravel (PHP) are used to manage tasks such as user authentication, data storage, and real-time updates.
Database Management: PostgreSQL or MySQL, or NoSQL databases like MongoDB or Firebase Realtime Database.
Real-time Updates: WebSockets, MQTT (Message Queuing Telemetry Transport), or Server-Sent Events (SSE) are utilized for instant communication between the server and clients.
Cloud Services: Amazon Web Services (AWS), Microsoft Azure, or Google Cloud Platform (GCP) handle scalability and provide reliable infrastructure for the parallel reality platform. Cloud services such as auto-scaling, load balancing, and content delivery networks (CDNs) help ensure optimal performance.
Security Measures: Implement appropriate security measures to protect user data, virtual element interactions, and ensure user privacy. Employ secure authentication and authorization mechanisms, follow security best practices, and comply with data protection regulations.

2f. Creating an Assembled Media Item: The platform server and/or database receive the scan or picture captured by the user's client device. This picture is then combined with at least one additional picture captured by another player who is also present at the first location. The result is an assembled media item.

2f (Expanded):
Media Creation and Editing: Adobe Creative Cloud Suite (Photoshop, Premiere Pro, After Effects), OpenCV (computer vision), FFmpeg (video editing), or other specialized libraries for image, audio, and video processing.
Backend Framework: A scalable backend framework to handle media storage, processing, and distribution. Node.js, Django (Python), Ruby on Rails (Ruby), or Laravel (PHP) handle the server-side logic required for media assembly and management.
Cloud Storage: Amazon S3, Google Cloud Storage, or Microsoft Azure Blob Storage to store media assets securely and provide scalable storage options. These services offer high availability, durability, and can handle large volumes of media content.
Media Transcoding and Encoding: AWS Elemental MediaConvert, Google Cloud Transcoder, or FFmpeg are utilized to transcode media files into different formats and resolutions.
Content Delivery Network (CDN): Cloudflare, Amazon CloudFront, or Akamai cache and deliver media assets from servers located strategically worldwide, reducing latency and improving performance.
Streaming Technologies: HLS (HTTP Live Streaming), DASH (Dynamic Adaptive Streaming over HTTP), or RTMP (Real-Time Messaging Protocol). These technologies enable adaptive bitrate streaming, ensuring smooth playback across different devices and network conditions.
Database Management: PostgreSQL, MySQL, MongoDB, or Firebase Realtime Database.
API Development and Integration: Express.js (Node.js), Django REST Framework (Python), or Ruby on Rails provide efficient API development capabilities. This allows for seamless integration with other platform features and services.
User Interfaces: HTML5, CSS, and JavaScript along with frontend frameworks React, Angular, or Vue.js. These frameworks allow the creation of user-friendly interfaces for assembling, editing, and viewing media items.
Security Measures: Implement robust security measures to protect media assets, user data, and ensure secure media transmission. Employ encryption protocols (e.g., SSL/TLS) for data in transit, implement proper authentication and authorization mechanisms, and follow security best practices for your chosen technologies.

2g. Updating Platform Data: The platform server and/or database update the platform data associated with the virtual element at the virtual location corresponding to the first location in the real world. The update includes incorporating the assembled media item into the platform data.

2g (Expanded):
Backend Framework: Node.js, Django (Python), Ruby on Rails (Ruby), or Laravel (PHP) handle the server-side logic required for data management and synchronization.
Database Management: PostgreSQL or MySQL handle structured data, while NoSQL databases MongoDB or Firebase Realtime Database manage unstructured or semi-structured data.
Real-time Data Updates: WebSockets, MQTT (Message Queuing Telemetry Transport), or Server-Sent Events (SSE) to enable real-time data updates and synchronization.
Data Synchronization: Implement data synchronization mechanisms to ensure consistency across different devices and users. Techniques used are conflict resolution, data versioning, or event-driven architectures to help maintain data integrity when multiple users update the same data concurrently.
API Development and Integration: Express.js (Node.js), Django REST Framework (Python), or Ruby on Rails provide efficient API development capabilities.
Caching Mechanisms: Redis or Memcached store frequently accessed data in memory, enabling faster retrieval and reducing the need for repeated data processing.
Security Measures: Implement appropriate security measures to protect data during updates. Follow security best practices for data transmission, authentication, and authorization. Additionally, comply with applicable data protection regulations to maintain data privacy and security.
Cloud Services: Amazon Web Services (AWS), Microsoft Azure, or Google Cloud Platform (GCP) handle scalability, data storage, and efficient data updates. Cloud services like auto-scaling, load balancing, and serverless computing help ensure high availability and optimize data update processes.
Monitoring and Logging: Prometheus, Grafana, ELK Stack (Elasticsearch, Logstash, Kibana), or cloud-specific monitoring services assist in monitoring and logging data updates.

2h. Providing Updated Platform Data to Second User: Finally, the platform server and/or database provide the updated platform data, which now includes the assembled media item, to a second client device belonging to a second user of the parallel reality platform. This enables the second user to access the updated information about the virtual element in the virtual world.

2h (Expanded):
Backend Framework: Node.js, Django (Python), Ruby on Rails (Ruby), or Laravel (PHP) handle the server-side logic required for data synchronization and delivery.
Real-time Data Synchronization: WebSockets, MQTT (Message Queuing Telemetry Transport), or Server-Sent Events (SSE) for real-time data synchronization between users.
Data Delivery: GraphQL, which enables efficient data retrieval and minimizes over-fetching or under-fetching of data. Additionally, optimizing data transfer protocols, compression techniques, or caching mechanisms to enhance data delivery performance.
API Development: Express.js (Node.js), Django REST Framework (Python), or Ruby on Rails provide capabilities for building robust and scalable APIs, facilitating data retrieval and delivery.
Database Management: PostgreSQL or MySQL, or NoSQL databases like MongoDB or Firebase Realtime Database.
Caching and Content Delivery: Redis or Memcached to store frequently accessed data in memory. Additionally, leverage content delivery networks (CDNs) Cloudflare, Amazon CloudFront, or Akamai to ensure efficient delivery of platform data to users across different regions.
Security Measures: Implement appropriate security measures to protect platform data during transmission and ensure data privacy. Apply encryption protocols (e.g., SSL/TLS) for data in transit, enforce proper authentication and authorization mechanisms, and follow security best practices for your chosen technologies.
Scalability and Cloud Services: Amazon Web Services (AWS), Microsoft Azure, or Google Cloud Platform (GCP) to handle scalability and provide reliable infrastructure for the parallel reality digital platform. Leverage cloud services like auto-scaling, load balancing, and serverless computing to accommodate increasing user loads and optimize data delivery.
Monitoring and Logging: Prometheus, Grafana, ELK Stack (Elasticsearch, Logstash, Kibana), or cloud-specific monitoring services assist in monitoring and logging data delivery processes.

(2) Summary: The described methods facilitate user interaction with virtual elements in a parallel reality platform, captures user-generated content through their client devices, and shares the updated information with other users in the platform.

3. The computer-implemented method described herein includes a process for incentivizing user interactions and consumer traffic at specific locations within a virtual world. Here is a breakdown of the steps involved:

3a. Identifying a Location and AR/VR Experience: The method begins by identifying a location in the virtual world corresponding to an official partner or reward provider hosting an AR or VR experience. This could be an image, item, environment, or structure associated with the specified location.

3b. Checking Client Device Interaction: The method determines if a client device has entered, scanned, or interacted with any object within a certain distance from or inside the region of the specified location. This is done to track user engagement and proximity to the designated areas.

3c. Delivering Customized Materials: If the client device enters the set location zone, customized materials, tasks, challenges, and prompts are received on the client device. These materials provide further details about the corresponding AR or VR experiences available at that location.

3d. User Interaction with AR/VR Experiences: The client device receives prompts and displays them to the user. The prompts encourage the user to view and interact with AR/VR experiences using the client device. The user can engage with the experiences through their device's interface.

3e. GPS Map and Navigation: An integrated GPS map API feature is displayed on the client device, providing the user with live AR/VR experience details and GPS navigation to and from parallel real-world locations. This feature helps users navigate to different locations within the virtual world based on the location of their client device in the real world.

3f. Sensing Client Device Entry: The method senses the client device entering the specified location by identifying an item or the location itself using the device's camera. This allows the system to recognize when the user has physically arrived at the designated location.

3g. Projecting AR/VR Elements: Augmented reality (AR) or virtual reality (VR) elements are projected onto items, images, or the vicinity within the location using an augmented-reality application executing on the client device. This enhances the user's experience by overlaying virtual elements onto the real-world environment.

3h. Completing Platform Tasks or Goals: Users can engage with the virtual world by completing platform tasks or goals. These tasks are designed to encourage user participation and further interaction with the AR/VR experiences at the specified locations.

3i. Qualification for Rewards: Upon completing platform tasks or goals, the system determines the user's qualification for a reward. This could be based on specific criteria or achievements within the virtual world.

3j. Notification and Reward Details: Users receive a notification displaying the reward item they have qualified for. This notification is shown when accessing the details of an AR/VR experience through the integrated GPS map. The reward details are presented to incentivize users to visit the specified location requested by official platform partners.

3k. Reward Reception: The client device receives the reward from the reward partner. This could involve redeeming a physical item, digital content, or any other form of reward determined by the official platform partners.

3l. Displaying Reward Details: The reward details are displayed on the client device, serving as an incentive for users to visit specified locations requested by official platform partners.

(3) Summary: The described method incentivizes user interactions and consumer traffic at specific locations within a virtual world by delivering customized materials, prompting user engagement with AR/VR experiences, providing GPS map and navigation features, and offering rewards for completing platform tasks or goals.

In one or more implementation, the gaming and incentive platform 100 and/or the gaming and incentive system 200 are implemented using one or more of:
Frontend Development: HTML5, CSS, and JavaScript along with frontend frameworks React, Angular, or Vue.js to create engaging user interfaces.
Backend Framework: Node.js, Django (Python), Ruby on Rails (Ruby), or Laravel (PHP) provide efficient tools for backend development.
Database Management: PostgreSQL or MySQL handle structured data, while NoSQL databases like MongoDB or Firebase Realtime Database manage unstructured or semi-structured data.
Gamification: Phaser, Unity, or PlayFab help in integrating gamification mechanics into the parallel reality digital platform.
Location-Based Services (LBS): Google Maps API, Mapbox, or OpenStreetMap assist in location tracking, geocoding, and routing functionalities.
Augmented Reality (AR) Development: ARKit (for iOS), ARCore (for Android), Unity 3D with Vuforia, or Unreal Engine.
Real-time Updates: WebSockets, MQTT (Message Queuing Telemetry Transport), or Server-Sent Events (SSE) for instant updates and interaction between users.
Cloud Services: Amazon Web Services (AWS), Microsoft Azure, or Google Cloud Platform (GCP) handle scalability and provide reliable infrastructure for the parallel reality digital platform. Leverage services like auto-scaling, serverless computing, or content delivery networks (CDNs) to optimize performance and ensure high availability.
Security Measures: Implement appropriate security measures to protect user data and ensure secure user interactions. Follow security best practices, employ encryption protocols (e.g., SSL/TLS) for data transmission, and enforce proper authentication and authorization mechanisms.
Analytics and Monitoring: Google Analytics, Mixpanel, or custom monitoring solutions provide insights into user behavior and help optimize your platform.

4. The computer system and mobile software application described is designed to create and manage a digital platform known as a metaverse. This metaverse functions as a large-scale virtual world where users can engage in augmented reality (AR) experiences and navigate through virtual environments parallel to the real world. Within this virtual world, advertising opportunities are provided to partnering businesses and presented exclusively to platform users.

The components and functionalities of the system include:

4a. Memory Unit: This component stores instructions for presenting the virtual world and allowing user navigation. The virtual world represents real-world locations and contains a variety of virtual experiences within the user's geographical region.

4a (Expanded):

Random Access Memory (RAM), Solid-State Drives (SSDs), Network Attached Storage (NAS), Content Delivery Networks (CDNs).

4b. Processor: The processor retrieves advertising information associated with AR/VR experiences and user profile information from a server or database. The user profile information includes details about the user's experiences, location, and reward preferences.

4b (Expanded):

Intel Xeon Processors, AMD EPYC Processors, ARM-based Processors, Custom or FPGA-based Processors.

4c. Presentation of Virtual World: The processor presents the virtual world on a display screen parallel to the real world. Users can navigate through both the virtual world and the real world using user input.

4d. Advertising Opportunities: The virtual world includes 2D and 3D objects that serve as advertising opportunities for partnering businesses and the platform itself. These advertising opportunities are presented to users based on their user profile information, behavioral data, and overall platform data.

4d (Expanded):

Ad Serving Platform: Google Ad Manager, DoubleClick for Publishers (DFP), or OpenX. These platforms provide features for ad inventory management, targeting, and reporting.

Real-Time Bidding (RTB) Integration: Google Marketing Platform, The Trade Desk, or MediaMath. These platforms allow for real-time bidding and automated ad buying based on user targeting criteria.

Data Management Platform (DMP): Salesforce Audience Studio, Lotame, or Adobe Audience Manager help collect, segment, and activate audience data to enhance ad campaigns' effectiveness.

Real-time User Tracking: Cookies, pixel tracking, or device identifiers are utilized to track user behavior, preferences, and engagement on the platform.

Demand Partners Integration: Google AdSense, Facebook Audience Network, or Amazon Advertising.

API Development: Express.js (Node.js), Django REST Framework (Python), or Ruby on Rails are used for efficient API development.

Database Management: PostgreSQL or MySQL, or NoSQL databases like MongoDB or Firebase Realtime Database.

Analytics and Reporting: Google Analytics, Adobe Analytics, or custom reporting solutions can provide insights into ad impressions, click-through rates, conversions, and revenue metrics.

Security Measures: Implement appropriate security measures to protect user data and ensure ad delivery compliance. Follow privacy regulations, employ encryption protocols (e.g., SSL/TLS) for data transmission, and enforce proper authentication and authorization mechanisms.

Cloud Services: Amazon Web Services (AWS), Microsoft Azure, or Google Cloud Platform (GCP) to handle scalability, storage, and compute requirements. Leverage services like auto-scaling, load balancing, or serverless computing to optimize performance and ensure high availability.

4e. Virtual Tasks and Objectives: The processor presents virtual tasks or objectives to users within the virtual world on the screen of their camera-equipped client device. These tasks can be related to specific experiences or locations within the virtual world.

4f. Rewards: Upon successful completion of a virtual task, the processor supplies digital and physical rewards to the user's virtual account database or server. These rewards can be redeemed or transferred over a communications network. Physical items awarded to users are shipped to them using a software automated ordering and shipping request handler.

4f (Expanded):

Backend Framework: Node.js, Django (Python), Ruby on Rails (Ruby), or Laravel (PHP) can handle the server-side logic required for reward processing and order fulfillment.

Database Management: PostgreSQL or MySQL, or NoSQL databases like MongoDB or Firebase Realtime Database.

Payment Gateway Integration: ApplePay, Zelle, PayPal, Stripe, Square, or Braintree. These gateways provide APIs and libraries for processing payments and managing transactions.

E-commerce Platform Integration: Shopify, WooCommerce, or Magento. These platforms provide functionalities for managing product catalogs, inventory, and order processing.

API Development: Express.js (Node.js), Django REST Framework (Python), or Ruby on Rails provide capabilities for building robust and scalable APIs.

User Authentication and Authorization: OAuth, JSON Web Tokens (JWT), or OpenID Connect to manage user authentication and authorization processes.

Order Fulfillment: Implement order fulfillment mechanisms to manage the processing, tracking, and delivery of physical rewards. This can include integration with shipping services or third-party logistics providers (3PLs) for efficient order management and tracking.

Notifications and Communication: Email, SMS gateways, or push notifications are utilized to send timely communications to users.

Security Measures: Implement appropriate security measures to protect user data, payment transactions, and ensure secure order processing. Follow security best practices, employ encryption protocols (e.g., SSL/TLS) for data transmission, and ensure compliance with relevant data protection regulations.

Cloud Services: Amazon Web Services (AWS), Microsoft Azure, or Google Cloud Platform (GCP) handle scalability, storage, and compute requirements. Leverage services like auto-scaling, load balancing, or serverless computing to optimize performance and ensure high availability.

(4) Summary: Overall, this system creates a metaverse where users can engage in augmented reality experiences, navigate virtual environments parallel to the real world, and encounter advertising opportunities. Users are incentivized to participate through virtual tasks and objectives, with the ability to earn rewards that can be redeemed digitally or received as physical items.

5. The computer-implemented method described herein includes operating and hosting augmented or virtual reality experiences at specific locations, which includes:

5a. List of Active AR/VR Experiences: The camera-equipped client device receives a list of AR/VR experiences that are currently active. Each experience indicates a reward being offered or a task to be completed within a specific geographic region or location.

5b. Determining Real World Locations: For each experience being hosted, the method determines a real-world location associated with that experience. This allows users to engage with the experiences at specific places in the physical world.

5c. Displaying Navigational Instructions: The client device displays real-world navigational instructions for each experience using an augmented reality software that integrates GPS map data. These instructions guide users to the designated locations where the experiences are hosted.

5d. Augmented Reality Interaction: Users interact with the experiences at the specified real-world locations. The camera-equipped client device captures user interactions and behaviors within the augmented reality environment.

5e. Confirmation of User Interactions: The client device confirms and records the user interactions and behaviors that occur at the location-based experiences. This information can be used for tracking progress, determining completion of tasks, and providing rewards.

(5) Summary: By following this method, users with camera-equipped client devices can access a list of active AR/VR experiences, receive navigational instructions based on their real-world locations, and engage with these experiences by completing tasks or interacting with the virtual elements. The method captures and confirms user interactions, allowing for further processing such as reward distribution or progress tracking.

6. Systems and methods for leasing or renting 3D space in a virtual world using augmented and virtual reality technology and software designed to provide entry portals or property management portals corresponding to the virtual world, and includes:

6a. Virtual World Creation: A virtual world is created using augmented and virtual reality technology and software. This virtual world consists of 3D space that can be leased or rented to individuals or businesses.

6b. Entry Portals: Entry portals are established within the virtual world to serve as access points for users and businesses who wish to lease or rent 3D space. These entry portals can be visual representations or virtual gateways that users can interact with using their augmented or virtual reality devices.

6c. Property Management Portals: Property management portals are created within the virtual world to facilitate the leasing or renting process. These portals serve as interfaces where users and businesses can search for available 3D spaces, view property details, and manage their leasing agreements.

6d. Leasing and Renting Process: Users or businesses who are interested in leasing or renting 3D space can access the virtual world through their augmented or virtual reality devices and navigate to the entry portals. From there, they can enter the property management portals to explore available spaces, access information about each space (such as size, location, and amenities), and review leasing terms and pricing.

6e. Interaction and Visualization: Augmented and virtual reality technology allows users to visually experience and interact with the 3D spaces within the virtual world. Users can virtually walk through the spaces, visualize the layout, and get a sense of the environment before making a decision.

6f. Lease or Rental Agreements: Once a user or business has selected a 3D space they are interested in, they can initiate the lease or rental process through the property management portal within the digital platform. This may involve providing personal information, signing agreements electronically, and making payments.

6g. Virtual World Integration: The leased or rented 3D space is then integrated into the virtual world, ensuring that it is reserved and designated for the specific user or business. Other users in the virtual world may see the space as occupied or unavailable.

(6) Summary: These systems and methods enable individuals and businesses to lease or rent 3D space within a virtual world using augmented and virtual reality technology. The entry portals and property management portals provide intuitive interfaces for users to explore, select, and manage their leased or rented spaces, while the visual and interactive capabilities of augmented and virtual reality enhance the overall leasing and renting experience.

Additionally, the system in some examples is implemented as:
Backend Framework: Node.js, Django (Python), Ruby on Rails (Ruby), or Laravel (PHP) handle the necessary functionalities.
Database Management: PostgreSQL or MySQL, or NoSQL databases like MongoDB or Firebase Realtime Database
Virtual World Creation: Unity 3D with Vuforia, Unreal Engine, or ARKit (for iOS) and ARCore (for Android) help in developing immersive virtual world experiences and integrating with the parallel reality digital platform.
Property Management Portals: React, Angular, or Vue.js are used to create user-friendly property management interfaces.
Payment Integration: ApplePay, Zelle, PayPal, Stripe, Square, or Braintree. These gateways provide APIs and libraries for processing payments and managing transactions.
User Authentication and Authorization: OAuth, JSON Web Tokens (JWT), or OpenID Connect to manage user authentication and authorization processes.
Communication and Notifications: Email, messaging systems, or push notifications are utilized to send messages, updates, or alerts regarding property leasing, bookings, or other relevant information.
Security Measures: Implement appropriate security measures to protect user data, transactions, and ensure secure property management. Follow security best practices, employ encryption protocols (e.g., SSL/TLS) for data transmission, and ensure compliance with relevant data protection regulations.
Cloud Services: Amazon Web Services (AWS), Microsoft Azure, or Google Cloud Platform (GCP) to handle scalability, storage, and compute requirements. Leverage services like auto-scaling, load balancing, or serverless computing to optimize performance and ensure high availability.

7. The computer-implemented method described herein includes collecting user data through an augmented reality or virtual reality geolocation digital platform, and includes:

7a. Deploying the platform: The augmented reality geolocation platform is deployed as a mobile application on a mobile computing device.

7b. Initiating the platform: The user initiates the augmented reality geolocation software feature on the mobile device. This action loads an instance of the platform's virtual world into the device's memory and retrieves user parameters such as location, profile status, and stored credentials.

7c. Generating tasks or objectives: The platform software, based on official partner criteria, generates tasks or objectives for the user to complete. These tasks can be in various formats such as text, audio, images, or 3D assets. The completion of these tasks provides digital or physical rewards to the user.

7d. Collecting user information: Through interactions with augmented or virtual reality experiences within the digital platform, user information is collected. This data is likely gathered based on the user's interactions with the platform and may include various types of information, such as user preferences, behaviors, or demographics.

7e. Generating additional tasks: The interactions with the digital platform and the collected user information are used to generate additional tasks or objectives for the user. These tasks are tailored to the individual user based on their interactions and collected data.

7f. Coordinating user coordinates: A GPS module on the mobile computing device, which is configured with the mobile application, coordinates the user's location in relation to an augmented reality or virtual reality experience within the digital platform. This allows for location-based experiences and rewards.

7g. Granting access to rewards: Based on the user's interactions and behavior at a specific location within the digital platform, which was determined by the official platform partner criteria, the user is granted access to a reward. The nature of the reward can vary, including digital rewards within the platform or physical rewards provided by the official platform partner.

(7) Summary: It's important to note that the method you described focuses on data collection and user engagement within an augmented reality or virtual reality geolocation platform. The specifics of how this data is used and managed, as well as considerations for user privacy and data protection, would depend on the implementation and policies of the platform.

One or more examples of the system are implemented as follows:

Frontend Development: HTML5, CSS, and JavaScript along with frontend frameworks React, Angular, or Vue.js to create immersive AR/VR experiences.

Geolocation Services: GPS, IP geolocation, or mobile device sensors are utilized to determine user location and provide location-based experiences within the AR/VR environment. Google Maps API, Mapbox, or OpenStreetMap assist in geolocation functionalities.

Backend Framework: Node.js, Django (Python), Ruby on Rails (Ruby), or Laravel (PHP) handle the server-side logic required for data management.

Database Management: PostgreSQL or MySQL, or NoSQL databases like MongoDB or Firebase Realtime Database.

User Authentication and Authorization: OAuth, JSON Web Tokens (JWT), or OpenID Connect to manage user authentication and authorization processes.

Data Collection and Processing: Event tracking libraries, custom data logging, or analytics tools assist in data collection.

Real-time Data Processing: Apache Kafka or Apache Pulsar for event streaming and processing.

Security Measures: Implement appropriate security measures to protect user data during transmission and storage. Follow security best practices, employ encryption protocols (e.g., SSL/TLS) for data in transit, and ensure compliance with relevant data protection regulations.

Cloud Services: Amazon Web Services (AWS), Microsoft Azure, or Google Cloud Platform (GCP) to handle scalability, storage, and compute requirements. Leverage services like auto-scaling, load balancing, or serverless computing to optimize performance and ensure high availability.

Analytics and Reporting: Google Analytics, Mixpanel, or custom analytics solutions assist in understanding user behaviors, preferences, and interactions within the AR/VR experience.

8. The system and methods described herein includes a client or business intake path and process within a large-scale parallel reality digital platform that hosts location-based augmented reality and virtual reality experiences. The platform also includes the storage and monitoring of both platform and user data, and is configured in some examples as follows:

8a. Intaking official platform partners: The platform intakes a variety of businesses as official platform partners. These partners likely have real-world locations corresponding to virtual elements within the platform. This allows the partners to have a presence in the virtual world and engage with platform users.

8b. Partner requests for virtual elements: The platform receives requests from the official platform partners to include virtual elements in the virtual world, specifically corresponding to their real-world locations. These virtual elements could be augmented reality or virtual reality content that enhances the user experience at the partner's physical location.

8c. Inclusion of virtual elements: Based on the partner requests, the platform incorporates the requested virtual elements into the virtual world. This process likely involves creating or integrating augmented reality or virtual reality content that is associated with specific real-world locations.

8d. Viewable data acquisition: The platform collects viewable data acquired from user interactions and behaviors within the platform. This data may include information such as user preferences, behaviors, or engagement patterns while interacting with the virtual elements and experiences.

8e. Storage and monitoring of platform and user data: The platform securely stores and monitors both platform data and user data. This ensures the data is properly managed, protected, and compliant with relevant privacy regulations.

(8) Summary: By performing these methods, the platform enables businesses to have a presence in the virtual world and leverage augmented reality or virtual reality experiences at their real-world locations. Meanwhile, the platform collects and analyzes data on user interactions and behaviors, which can provide valuable insights for both the platform and its official partners. One or more examples are configured as follows:

Frontend Development: HTML5, CSS, and JavaScript along with frontend frameworks React, Angular, or Vue.js to create a user-friendly intake path and process interface.

Backend Framework: Node.js, Django (Python), Ruby on Rails (Ruby), or Laravel (PHP) handle the necessary functionalities.

Database Management: PostgreSQL or MySQL, or NoSQL databases like MongoDB or Firebase Realtime Database.

User Registration and Authentication: OAuth, JSON Web Tokens (JWT), or OpenID Connect to manage user authentication and authorization processes.

Integration with Location-Based Services: Google Maps API, Mapbox, or OpenStreetMap assist in location tracking, geocoding, and routing functionalities.

Communication Channels: Email integration, messaging systems, or chatbot functionalities handle inquiries, support requests, or feedback.

Workflow Management: Trello, Asana, or custom workflow management solutions help in managing tasks, approvals, and tracking progress.

Security Measures: Implement appropriate security measures to protect user data, communication records, and ensure secure client or business intake. Follow security best practices, employ encryption protocols (e.g., SSL/TLS) for data transmission, and ensure compliance with relevant data protection regulations.

Cloud Services: Amazon Web Services (AWS), Microsoft Azure, or Google Cloud Platform (GCP) to handle scalability, storage, and compute requirements. Leverage services like auto-scaling, load balancing, or serverless computing to optimize performance and ensure high availability.

Analytics and Reporting: Google Analytics, Mixpanel, or custom reporting solutions provide insights into user behavior and help optimize the intake path and process.

In various examples, the specific implementation, data management practices, and privacy considerations depend on the platform's design and policies.

Thus, improvements to incentivized gaming systems or other rewards or loyalty systems are provided. For example, one or more examples can be implemented in a loyalty reward environment that includes AR and/or VR gamification that can be easily managed on the user side and on the merchant or business side.

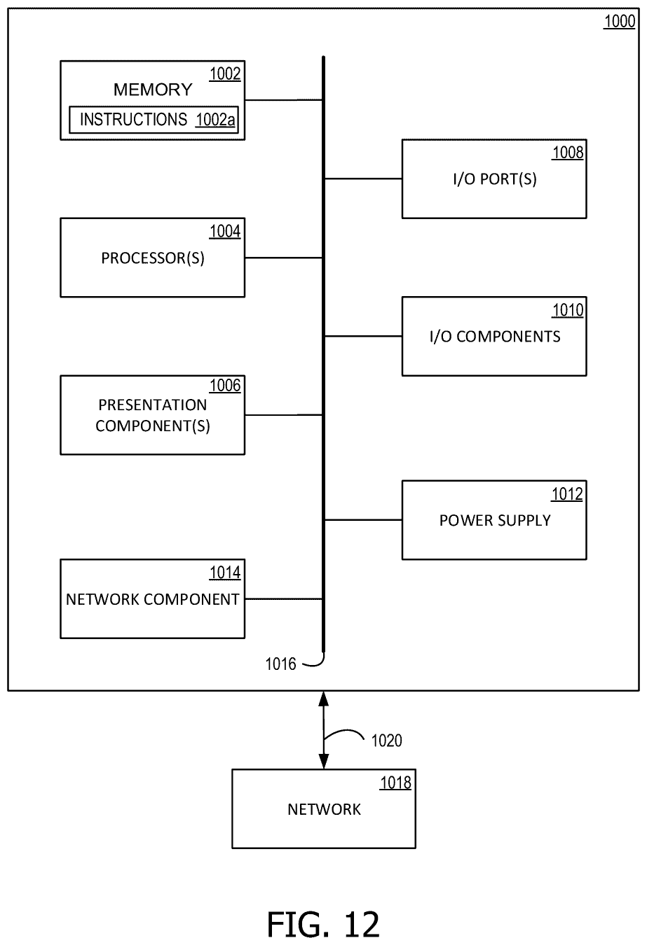

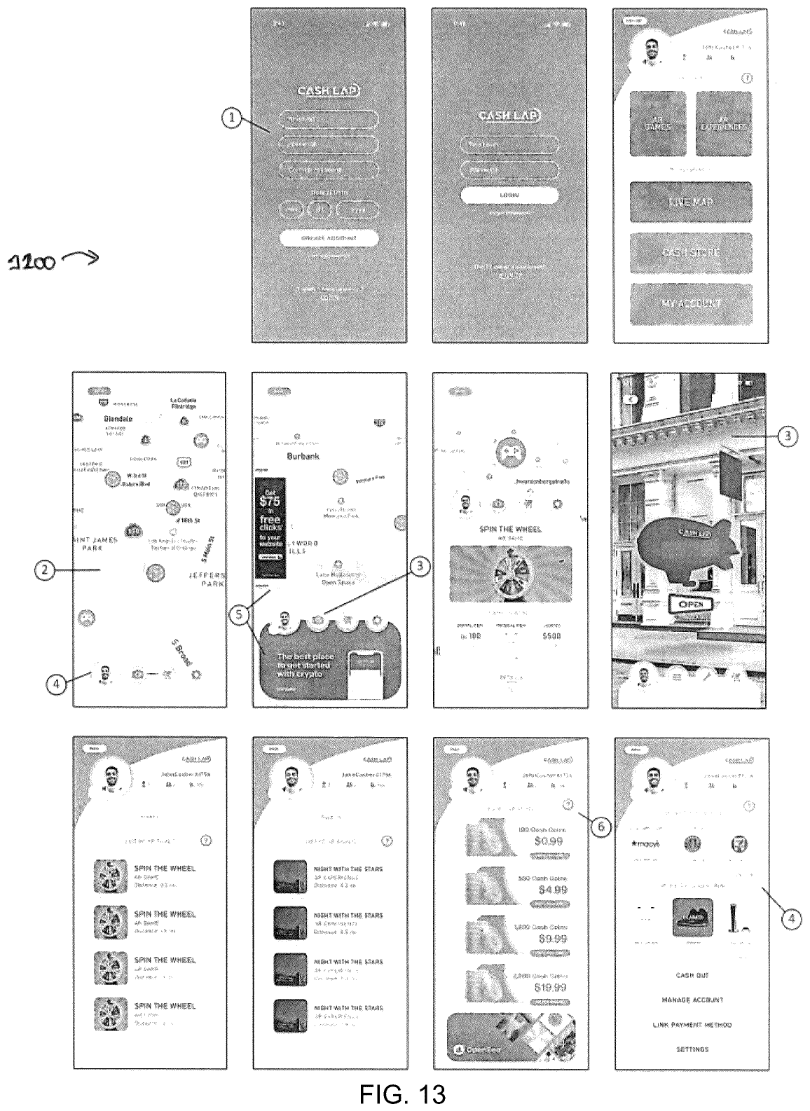

With reference now to FIG. 12, a block diagram of the computing device 1000 suitable for implementing various aspects of the disclosure is described (e.g., the gaming and incentive platform 100 and/or the gaming and incentive system 200) and can include one or more user interfaces 1100 (See FIG. 13). FIG. 12 and the following discussion provide a brief, general description of a computing environment in/on which one or more or the implementations of one or more of the methods and/or system set forth herein may be implemented. The operating environment of FIG. 12 is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

In some examples, the computing device 1000 includes a memory 1002, one or more processors 1204, and one or more presentation components 1006. The disclosed examples associated with the computing device 1000 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 12 and the references herein to a “computing device.” The disclosed examples are also practiced in distributed computing environments, where tasks are performed by remote-processing devices that are linked through a communications network. Further, while the computing device 1000 is depicted as a single device, in one example, multiple computing devices work together and share the depicted device resources. For instance, in one example, the memory 1002 is distributed across multiple devices, the processor(s) 1004 provided are housed on different devices, and so on.

In one example, the memory 1002 includes any of the computer-readable media discussed herein. In one example, the memory 1002 is used to store and access instructions 1002a configured to carry out the various operations disclosed herein. In some examples, the memory 1002 includes computer storage media in the form of volatile and/or nonvolatile memory, removable or non-removable memory, data disks in virtual environments, or a combination thereof. In one example, the processor(s) 1004 includes any quantity of processing units that read data from various entities, such as the memory 1002 or input/output (I/O) components 1010. Specifically, the processor(s) 1004 are programmed to execute computer-executable instructions for implementing aspects of the disclosure. In one example, the instructions 1002a are performed by the processor 1004, by multiple processors within the computing device 1000, or by a processor external to the computing device 1000. In some examples, the processor(s) 1004 are programmed to execute instructions such as those illustrated in the flow charts discussed herein and depicted in the accompanying drawings.

In other implementations, the computing device 1000 may include additional features and/or functionality. For example, the computing device 1000 may also include additional storage (e.g., removable and/or non-removable) including, but not limited to, magnetic storage, optical storage, and the like. Such additional storage is illustrated in FIG. 12 by the memory 1002. In one implementation, computer readable instructions to implement one or more implementations provided herein may be in the memory 1002 as described herein. The memory 1002 may also store other computer readable instructions to implement an operating system, an application program and the like. Computer readable instructions may be loaded in the memory 1202 for execution by the processor(s) 1004, for example.

The presentation component(s) 1006 present data indications to an operator or to another device. In one example, the presentation components 1006 include a display device, speaker, printing component, vibrating component, etc. One skilled in the art will understand and appreciate that computer data is presented in a number of ways, such as visually in a graphical user interface (GUI), audibly through speakers, wirelessly between the computing device 1000, across a wired connection, or in other ways. In one example, the presentation component(s) 1006 are not used when processes and operations are sufficiently automated that a need for human interaction is lessened or not needed. I/O ports 1008 allow the computing device 1000 to be logically coupled to other devices including the I/O components 1010, some of which is built in. Implementations of the I/O components 1010 include, for example but without limitation, a microphone, keyboard, mouse, joystick, pen, game pad, satellite dish, scanner, printer, wireless device, camera, etc.

The computing device 1000 includes a bus 1016 that directly or indirectly couples the following devices: the memory 1002, the one or more processors 1004, the one or more presentation components 1006, the input/output (I/O) ports 1008, the I/O components 1010, a power supply 1012, and a network component 1014. The computing device 1000 should not be interpreted as having any dependency or requirement related to any single component or combination of components illustrated therein. The bus 1016 represents one or more busses (such as an address bus, data bus, or a combination thereof). Although the various blocks of FIG. 12 are shown with lines for the sake of clarity, some implementations blur functionality over various different components described herein.

The components of the computing device 1000 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 1000 may be interconnected by a network. For example, the memory 1002 may be comprised of multiple physical memory units located in different physical locations interconnected by a network.

In some examples, the computing device 1000 is communicatively coupled to a network 1018 using the network component 1014. In some examples, the network component 1014 includes a network interface card and/or computer-executable instructions (e.g., a driver) for operating the network interface card. In one example, communication between the computing device 1000 and other devices occurs using any protocol or mechanism over a wired or wireless connection 1020. In some examples, the network component 1014 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 1020 may include, but is not limited to, a modem, a Network Interface Card (NIC), an integrated network interface, a radio frequency transmitter/receiver, an infrared port, a USB connection or other interfaces for connecting the computing device 1000 to other computing devices. The connection 1020 may transmit and/or receive communication media.

Although described in connection with the computing device 1000, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A gaming and incentive system, comprising:
a processor; and
a computer-readable medium storing non-transitory instructions that are operative upon execution by the processor to operate:
a business path portal configured to allow control of a business experience management sub-system and comprising a business path portal user interface;
a gaming user interface configured to allow user interaction with AR/VR experiences managed via the business path portal, the gaming user interface being a software based user interface configured as one of a mobile application user experience, a VR headset application user experience, or a CPU application user experience, the gaming user interface configured to provide information on one or more of AR/VR games, advertisements, experiences, and 3D objects;
a location information sub-system configured to present a GPS map via the gaming user interface, the GPS map displaying locations of one or more location-based AR experiences, games, advertising, 3D objects, and events;
a consumer path portal configured to allow access to the AR/VR experiences, and receive one or more user inputs to locate, view, interact, and transact with the location-based AR/VR experiences;
a prize management system configured to allow management of incentive prizes, including using user behavioral data and algorithms to determine possible rewards, wherein the rewards comprise one of physical rewards and virtual rewards; and
a tracking component configured to track user data and provide behavioral analytics.

2. The gaming and incentive system of claim 1, wherein the non-transitory instructions are further operative upon execution by the processor to generate one or more of advertising content or promotional content displayed within an AR/VR gaming environment implementing the AR/VR experiences.

3. The gaming and incentive system of claim 2, wherein the non-transitory instructions are further operative upon execution by the processor to display the advertising content or promotional content in a leased AR space within the AR/VR gaming environment.

4. The gaming and incentive system of claim 1, wherein the non-transitory instructions are further operative upon execution by the processor to access and/or download an application and create a user account.

5. The gaming and incentive system of claim 1, wherein the non-transitory instructions are further operative upon execution by the processor to present an integrated map feature that displays a location of the user along with a plurality of points of interest and details and/or relevance of each point of interest.

6. The gaming and incentive system of claim 1, wherein the non-transitory instructions are further operative upon execution by the processor to initiate an AR camera feature operable with a camera of a mobile device of the user to view and interact with one or more of content, games, or experiences overlaid onto a live image displayed on the mobile device.

7. The gaming and incentive system of claim 1, wherein the non-transitory instructions are further operative upon execution by the processor to receive one or more user inputs via an account management component to change personal information used to identify the user.

8. The gaming and incentive system of claim 1, wherein the non-transitory instructions are further operative upon execution by the processor to cause the gaming user interface to generate a gamified user interface configured to incentivize the user to visit one or more physical or virtual locations.

9. The gaming and incentive system of claim 1, wherein the non-transitory instructions are further operative upon execution by the processor to integrate advertising and promotional opportunities into the gaming user interface.
